(19) United States
(12) Patent Application Publication
(10) Pub. No.: US 2019/0028997 A1
(43) Pub. Date: Jan. 24, 2019

(54) WEARABLE DEVICE, CONTROL TARGET DEVICE, SHORT-RANGE WIRELESS COMMUNICATION NETWORK, COMMUNICATION SYSTEM, CONTROL SYSTEM, AND REMOTE CONTROL METHOD

(71) Applicant: SEIKO EPSON CORPORATION, Tokyo (JP)

(72) Inventors: Katsutoyo INOUE, Azumino-shi (JP); Hiroaki HOSOMI, Minowa-machi (JP)

(73) Assignee: SEIKO EPSON CORPORATION, Tokyo (JP)

(21) Appl. No.: 16/070,400

(22) PCT Filed: Jan. 23, 2017
(86) PCT No.: PCT/JP2017/002154

§ 371 Date: Jul. 16, 2018

(30) Foreign Application Priority Data
Jan. 29, 2016 (JP) 2016-015937
Jan. 29, 2016 (JP) 2016-015938
Jan. 29, 2018 (JP) 2016-015841

(51) Int. Cl. H04W 68/00; H04W 4/80; H04W 4/029; H04W 68/12; G06F 1/16

(52) U.S. Cl. CPC H04W 68/005; H04W 4/80; H04W 88/02; H04W 68/12; G06F 1/163; H04W 4/029

(57) ABSTRACT

A wearable device, a communication system, and the like that can improve constant connectivity of the wearable device to a computer communication network and enable realization of notification processing suitable for the wearable device. A wearable device WD includes a processing section configured to process information and a communication section configured to perform loosely coupled short-range wireless communication between the communication section and an external device. The communication section is communicatively connected to a gateway device GW, to which an unspecified large number of devices are connectable, by the loosely coupled short-range wireless communication and communicatively connected to a computer communication network via the gateway device GW. The processing section performs notification processing of notification information acquired on the basis of transmission of information concerning the wearable device by the loosely coupled short-range wireless communication.

### TECHNICAL FIELD

The present invention relates to a wearable device, a control target device, a short-range wireless communication network, a communication system, a control system, a remote control method, and the like.

### BACKGROUND ART

In recent years, wearable devices such as a wrist-type electronic device are in the spotlight. Such wearable devices highly accurately acquire information concerning the body and the behavior of a user to enable provision of valuable information needed by the user. Therefore, the wearable devices such as the wrist-type electronic device are requested to be excellent in constant wearability and requested to have constant connectivity to a computer communication network such as the Internet. In recent years, IoT (Internet of Things), which is a technique for connecting various objects present in the world to the Internet, attracts attention. The wearable devices are desired to contribute to realization of such IoT.

As related art of such wearable devices, there is, for example, a technique disclosed in PTL 1. In FIG. 67 of PTL 1, a figure is shown in which a digital watch is connected to a cellular phone and a computer (link 1320).

PTL 2 discloses related art for measuring residual battery power of a watch (a wristwatch). PTL 3 discloses related art concerning a driving method for a motor included in a watch.

Various techniques concerning a home automation system for improving convenience of users have been proposed. Use of the home automation system enables remote operation for, for example, turning on a power supply of a heating device or readying a bath in a home from a visiting destination. As related art of such a home automation system, there is, for example, a technique disclosed in PTL 4. In the relate art, a user performs remote operation of a control target device from a cellular phone carried by the user through a control center.

### CITATION LIST

### Patent Literature

PTL 1: U.S. Pat. No. 8,688,406

PTL 2: JP-A-2015-222269

PTL 3: JP-A-59-109889

PTL 4: JP-A-2006-19419

### SUMMARY OF INVENTION

### Technical Problem

In the related art disclosed in PTL 1, the digital watch is connected to the Internet through the cellular phone or the computer rather than being directly connected to the Internet. However, the digital watch cannot be independently connected to the Internet. Therefore, it is difficult to satisfy a request for constant connectivity to a computer communication network.

The related art disclosed in PTL 2 is a technique concerning a method of measuring a voltage of a battery. In a battery having a small capacity, because a voltage gently drops as time elapses, battery exhaustion can be predicted beforehand to a certain degree. However, in a battery having a large capacity, because a voltage suddenly drops as time elapses, battery exhaustion can be predicted only immediately before the battery exhaustion. Practically, in the present situation, the battery exhaustion cannot be predicted beforehand.

In the related art disclosed in PTL 4, in order to perform the remote control of the control target device, the user needs to communicatively connect the cellular phone to the control center and perform request operation for the remote control of the control target device. Therefore, automatic remote control cannot be realized. When the user does not carry a cellular phone, because the user cannot make communicative connection to the control center, the user cannot perform the request for the remote control either.

According to several aspects of the invention, it is possible to provide a wearable device, a communication system, and the like that can improve, for example, constant connectivity of the wearable device to a computer communication network and enable realization of notification processing suitable for the wearable device.

According to several aspects of the invention, it is possible to provide a wearable device, a communication system, and the like that can improve, for example, constant connectivity of the wearable device to a computer communication network and enable realization of various kinds of processing based on monitoring information of the wearable device.

According to several aspects of the invention, it is possible to provide a communication system, a short-range wireless communication network, a wearable device, and the like that can improve, for example, constant connectivity of the wearable device to the computer communication network.

According to several aspects of the invention, it is possible to provide a control system, a control target device, a wearable device, a remote control method, and the like that can realize automatic remote control of a control object using a wearable device worn by a user.

### Solution to Problem

[First aspect] An aspect of the invention relates to a wearable device including: a processing section configured to process information; and a communication section configured to perform loosely coupled short-range wireless communication between the communication section and an external device. The communication section is communicatively connected to a gateway device, to which an unspecified large number of devices are connectable, by the loosely coupled short-range wireless communication and communicatively connected to the computer communication network via the gateway device. The processing section performs notification processing of notification information acquired on the basis of transmission of information concerning the wearable device by the loosely coupled short-range wireless communication.

In the aspect of the invention, the wearable device includes the processing section and the communication section. The communication section is communicatively connected to the gateway device by the loosely coupled short-range wireless communication and communicatively connected to the computer communication network via the gateway device. The information concerning the wearable device is transmitted by the loosely coupled short-range wireless communication. When the notification information is acquired by the loosely coupled short-range wireless communication, the notification processing of the notification information is performed. It is possible to improve constant connectivity and the like of the wearable device by using the loosely coupled short-range wireless communication in this way. Consequently, it is possible to realize notification processing suitable for the wearable device by performing the notification processing of the acquired notification information.

[Second aspect] In the aspect of the invention, the processing section may perform notification processing for notifying of maintenance information concerning maintenance of the wearable device.

In this way, it is possible to notify of the maintenance information of the wearable device effectively utilizing the loosely coupled short-range wireless communication. It is possible to realize improvement of convenience, improvement of the quality of the wearable device, and the like.

[Third aspect] In the aspect of the invention, the processing section may perform notification processing for notifying of, as the maintenance information, announcement information concerning a maintenance service for the wearable device.

In this way, it is possible to perform announcement concerning the maintenance service for the wearable device effectively utilizing the loosely coupled short-range wireless communication.

[Fourth aspect] In the aspect of the invention, the processing section may perform notification processing for notifying of, as the notification information, operable time information representing an operable time of the wearable device.

In this way, it is possible to notify of more highly accurate operable time information of the wearable device effectively utilizing the loosely coupled short-range wireless communication.

[Fifth aspect] In the aspect of the invention, the communication section may transmit, as the information concerning the wearable device, monitoring information concerning at least one of an operation state and an environment of use of the wearable device to the gateway device through the loosely coupled short-range wireless communication.

In this way, the monitoring information concerning the operation state and the environment of use of the wearable device can be delivered to the computer communication network via the gateway device using the loosely coupled short-range wireless communication. It is possible to execute appropriate notification processing using the monitoring information.

[Sixth aspect] Another aspect of the invention relates to a wearable device including: a processing section configured to process information; and a communication section configured to perform loosely coupled short-range wireless communication between the communication section and an external device. The communication section is communicatively connected to a gateway device, to which an unspecified large number of devices are connectable, by the loosely coupled short-range wireless communication and communicatively connected to the computer communication network via the gateway device. The communication section transmits monitoring information concerning at least one of an operation state and an environment of use of the wearable device to the gateway device through the loosely coupled short-range wireless communication.

In the aspect of the invention, the communication section of the wearable device is communicatively connected to the gateway device by the loosely coupled short-range wireless communication and communicatively connected to the computer communication network via the gateway device. The monitoring information concerning the operation state or the environment of use of the wearable device can be delivered to the communication network via the gateway device using the loosely coupled short-range wireless communication. It is possible to realize various kinds of processing using the monitoring information.

[Seventh aspect] In the aspect of the invention, the processing section may perform monitoring processing of a device included in the wearable device, and the communication section may transmit the monitoring information acquired by the monitoring processing to the gateway device through the loosely coupled short-range wireless communication.

In this way, the monitoring information acquired by the monitoring processing of the device included in the wearable device can be delivered to the computer communication network via the gateway device using the loosely coupled short-range wireless communication. It is possible to realize various kinds of processing using the monitoring information.

[Eighth aspect] In the aspect of the invention, the processing section may perform monitoring processing concerning a plurality of monitoring items of the device and acquire at least one of statistical information concerning each monitoring item of the plurality of monitoring items and time-series log information concerning the each monitoring item, and the communication section may transmit the at least one of the statistical information and the log information to the gateway device through the loosely coupled short-range wireless communication.

In this way, the monitoring processing concerning the plurality of monitoring items of the wearable device is performed. The statistical information or the log information obtained by the monitoring processing can be delivered to the computer communication network via the gateway device using the loosely coupled short-range wireless communication. Consequently, it is possible to realize various kinds of processing using the statistical information or the log information.

[Ninth aspect] In the aspect of the invention, the wearable device may be a watch including turning hands, and the device may be a motor that drives the hands.

In this way, monitoring processing concerning the motor for driving the hands of the watch, which is the wearable device, is performed. Monitoring information obtained by the monitoring processing can be delivered to the computer communication network via the gateway device using the loosely coupled short-range wireless communication.

[Tenth aspect] In the aspect of the invention, the device may be a power generating section configured to generate electric power for operating the processing section and the communication section, the processing section may perform monitoring processing of at least one of power generation amount information, power consumption amount information, and power balance information of the power generating section, and the communication section may transmit at least one of the power generation amount information, the power consumption amount information, and the power balance information to the gateway device through the loosely coupled short-range wireless communication.

In this way, when the wearable device includes the power generating section for operating the processing section and the communication section, monitoring information concerning the power generation amount information, the power consumption amount information, or the power balance information of the power generating section can be delivered to the computer communication network via the gateway device using the loosely coupled short-range wireless communication. Consequently, it is possible to execute various kinds of processing executable by grasping information concerning a power generation amount, a power consumption amount, and a power balance.

[Eleventh aspect] In the aspect of the invention, the communication section may transmit, as the monitoring information concerning the environment of use of the wearable device, at least one of magnetic field information, temperature information, humidity information, air pressure information, magnetism information, weather information, gravity information, acceleration information, radiation information, illuminance information, and position information of the wearable device to the gateway device through the loosely coupled short-range wireless communication.

In this way, the magnetic field information, the temperature information, the humidity information, the air pressure information, the magnetism information, the weather information, the gravity information, the acceleration information, the radiation information, the illuminance information, or the position information of the wearable device can be delivered to the computer communication network via the gateway device using the loosely coupled short-range wireless communication. Consequently, it is possible to execute various kinds of processing executable by grasping these kinds of information.

[Twelfth aspect] In the aspect of the invention, the loosely coupled short-range wireless communication may be communication performed in a scan period in which the gateway device searches for a presence notification packet transmitted from the wearable device.

In this way, it is possible to realize the loosely coupled short-range wireless communication effectively utilizing the presence notification packet transmitted by the wearable device in the scan period.

[Thirteenth aspect] In the aspect of the invention, the communication section may transmit information to the gateway device using the presence notification packet or, when the gateway device transmits a request packet in response to the presence notification packet, transmit information to the gateway device using a response packet to the request packet.

In this way, information can be transmitted from the wearable device to the gateway device using the presence notification packet. Information can be transmitted from the wearable device to the gateway device using the response packet to the request packet transmitted in response to the presence notification packet.

[Fourteenth aspect] In the aspect of the invention, the communication section may receive, in the scan period, from the computer communication network through the loosely coupled short-range wireless communication via the gateway device, information acquired on the basis of information transmitted to the computer communication network via the gateway device.

In this way, in the scan period, when the wearable device transmits information to the computer communication network, the wearable device can receive, in the scan period, information acquired on the basis of the information. Consequently, it is possible to realize directional communication by the loosely coupled short-range wireless communication.

[Fifteenth aspect] In the aspect of the invention, the presence notification packet and the scan period may be respectively an advertising packet and an active scan period in a Bluetooth (registered trademark).

In this way, it is possible to realize the loosely coupled short-range wireless communication using the advertising packet and the active scan period in the Bluetooth.

[Sixteenth aspect] In the aspect of the invention, the communication section may perform, in a first period, the loosely coupled short-range wireless communication between the communication section and a first gateway device included in a short-range wireless communication network and perform, in a second period different from the first period, the loosely coupled short-range wireless communication between the communication section and a second gateway device included in the short-range wireless communication network.

In this way, it is possible to realize, for example, constant connection between the wearable device and the computer communication network using the loosely coupled short-range wireless communication while sequentially switching gateway devices, which are connection destinations of the wearable device.

[Seventeenth aspect] In the aspect of the invention, the communication section may be communicatively connected to the gateway device by the loosely coupled short-range wireless communication directly not via another information communication terminal.

In this way, it is possible to communicatively connect the wearable device to the computer communication network without requiring an information communication terminal. It is possible to improve the constant connectivity and the like.

[Eighteenth aspect] Still another aspect of the invention relates to a wearable device including: a processing section configured to process information; and a communication section configured to perform short-range wireless communication between the communication section and a gateway device communicatively connected to a computer communication network. The communication section is communicatively connected to the computer communication network via the gateway device by performing the short-range wireless communication with the gateway device in a scan period in which the gateway device searches for a presence notification packet transmitted from the wearable device. The processing section performs notification processing of notification information acquired on the basis of transmission of information concerning the wearable device by the short-range wireless communication.

According to the other aspect of the invention, the wearable device can be communicatively connected to the computer communication network via the gateway device by the short-range wireless communication performed in the scan period in which the gateway device searches for the presence notification packet. The information concerning the wearable device is transmitted by the short-range wireless communication in the scan period. When the notification information is acquired by the transmission of the information, the notification processing of the notification information is executed. Consequently, it is possible to improve the constant connectivity and the like of the wearable device and realize suitable notification processing.

[Nineteenth aspect] In the other aspect of the invention, the communication section may transmit information to the gateway device using the presence notification packet or, when the gateway device transmits a request packet in response to the presence notification packet, transmit information to the gateway device using a response packet to the request packet.

[Twentieth aspect] In the other aspect of the invention, the communication section may receive, in the scan period, from the computer communication network through short-range wireless communication via the gateway device, information acquired on the basis of information transmitted to the computer communication network via the gateway device.

[Twenty-first aspect] In the other aspect of the invention, the presence notification packet and the scan period may be respectively an advertising packet and an active scan period in a Bluetooth (registered trademark).

[Twenty-second aspect] In the other aspect of the invention, the communication section may perform, in a first period, the short-range wireless communication between the communication section and a first gateway device included in a short-range wireless communication network and perform, in a second period different from the first period, the short-range wireless communication between the communication section and a second gateway device included in the short-range wireless communication network.

[Twenty-third aspect] Still another aspect of the invention relates to a communication system including: a wearable device including a processing section configured to process information and a communication section configured to perform loosely coupled short-range wireless communication between the communication section and an external device; and a short-range wireless communication network including a gateway device, to which an unspecified large number of devices are connectable, and connectable to a computer communication network. The wearable device is communicatively connected to the gateway device by the loosely coupled short-range wireless communication and communicatively connected to the computer communication network via the gateway device. Notification processing to a user is performed concerning notification information acquired on the basis of transmission of information concerning the wearable device by the loosely coupled short-range wireless communication.

[Twenty-fourth aspect] In the other aspect of the invention, the loosely coupled short-range wireless communication may perform communication performed in a scan period in which the gateway device searches for a presence notification packet transmitted from the wearable device.

According to the other aspect of the invention, the short-range wireless communication network including the gateway device and connectable to the computer communication network is provided. The processing section and the communication section are provided in the wearable device. The wearable device is communicatively connected to the gateway device by the loosely coupled short-range wireless communication and communicatively connected to the computer communication network via the gateway device. When the information concerning the wearable device is transmitted by the loosely coupled short-range wireless communication and the notification information is acquired according to the transmission of the information, the notification processing of the notification information is executed. Consequently, it is possible to improve the constant connectivity and the like of the wearable device and realize suitable notification processing.

[Twenty-fifth aspect] An aspect of the invention relates to a control system including: a wearable device including a processing section configured to process information and a communication section configured to perform loosely coupled short-range wireless communication between the communication section and an external device; a short-range wireless communication network including a gateway device, to which an unspecified large number of devices are connectable, and connectable to a computer communication network; and a control object used by a user. The wearable device is communicatively connected to the gateway device by the loosely coupled short-range wireless communication and communicatively connected to the computer communication network via the gateway device. The control object is automatically remotely controlled by the computer communication network.

In the aspect of the invention, the short-range wireless communication network including the gateway device and connectable to the computer communication network is provided. The wearable device worn by the user is communicatively connected to the gateway device by the loosely coupled short-range wireless communication and communicatively connected to the computer communication network via the gateway device. The control object used by the user is automatically remotely controlled by the computer communication network. In this way, the wearable device of the user can be communicatively connected to the computer communication network using the loosely coupled short-range wireless communication. The control object used by the user can be remotely controlled. Therefore, it is possible to provide a control system that can realize automatic remote control of the control object using the wearable device worn by the user.

[Twenty-sixth aspect] In the control system according to the twenty-fifth aspect, authentication processing of the user may be performed, and remote control of the control object for preferentially processing the user authenticated by the authentication processing may be performed.

In this way, when the user is authenticated by the authentication processing, the remote control of the control object for preferentially processing the user is performed. It is possible to provide a service of remote control with a higher added value to the user.

[Twenty-seventh aspect] In the control system according to the twenty-fifth or twenty-sixth aspect, behavior prediction processing of the user may be performed, and the remote control of the control object may be performed on the basis of a result of the behavior prediction processing.

In this way, it is possible to perform the behavior prediction processing of the user and realize appropriate remote control of the control object corresponding to predicted behavior.

[Twenty-eighth aspect] In the control system according to the twenty-seventh aspect, the behavior prediction processing of the user may be performed on the basis of at least one of information acquired from the wearable device by the loosely coupled short-range wireless communication and schedule information of the user.

In this way, it is possible to perform the behavior prediction processing of the user reflecting the information acquired from the wearable device by the loosely coupled short-range wireless communication or the schedule information of the user and realize appropriate remote control of the control object corresponding to predicted behavior.

[Twenty-ninth aspect] In the control system according to the twenty-seventh or twenty-eighth aspect, the behavior prediction processing of the user may be performed on the basis of connection history information of a plurality of the gateway devices communicatively connected to the wearable device by the loosely coupled short-range wireless communication.

In this way, it is possible to perform behavior processing of the user and realize the remote control of the control object effectively utilizing the connection history information of the plurality of gateway devices communicatively connected to the wearable device by the loosely coupled short-range wireless communication.

[Thirtieth aspect] In the control system according to any one of the twenty-fifth to twenty-ninth aspects, the loosely coupled short-range wireless communication may be communication performed in a scan period in which the gateway device searches for a presence notification packet transmitted from the wearable device.

In this way, it is possible to realize the loosely coupled short-range wireless communication effectively utilizing the presence notification packet transmitted by the wearable device in the scan period.

[Thirty-first aspect] In the control system according to the thirtieth aspect, the wearable device may transmit information to the gateway device using the presence notification packet or, when the gateway device transmits a request packet in response to the presence notification packet, transmit information to the gateway device using a response packet to the request packet.

In this way, information can be transmitted from the wearable device to the gateway device using the presence notification packet. Information can be transmitted from the wearable device to the gateway device using the response packet to the request packet transmitted in response to the presence notification packet.

[Thirty-second aspect] In the control system according to thirtieth or thirty-first aspect, the presence notification packet and the scan period may be respectively an advertising packet and an active scan period in a Bluetooth (registered trademark).

In this way, it is possible to realize the loosely coupled short-range wireless communication using the advertising packet and the active scan period in the Bluetooth.

[Thirty-third aspect] Still another aspect of the invention relates to a control target device, which is the control object of the control system according to any one of the twenty-fifth to thirty-second aspects.

[Thirty-fourth aspect] Still another aspect of the invention relates to a wearable device including: a processing section configured to process information; and a communication section configured to perform loosely coupled short-range wireless communication between the communication section and an external device. The communication section is communicatively connected to a gateway device, to which an unspecified large number of devices are connectable, by the loosely coupled short-range wireless communication and communicatively connected to the computer communication network via the gateway device. The processing section performs processing for automatically remotely controlling, with the computer communication network, a control object used by a user.

According to the other aspect of the invention, the wearable device of the user can be communicatively connected to the computer communication network using the loosely coupled short-range wireless communication. The control object used by the user can be remotely controlled. Therefore, it is possible to realize the automatic remote control of the control object using the wearable device worn by the user.

[Thirty-fifth aspect] In the wearable device according to the aspect 34, the communication section may transmit information for authentication of the user for performing remote control for preferentially processing the user to the gateway device through the loosely coupled short-range wireless communication.

In this way, it is possible to perform authentication processing of the user on the basis of the information for authentication transmitted by the loosely coupled short-range wireless communication and execute remote control of the control object for preferentially treating the authenticated user.

[Thirty-sixth aspect] In the wearable device according to the thirty-fourth or thirty-fifth aspect, the communication section may transmit information for behavior prediction for performing behavior prediction processing of the user to the gateway device through the loosely coupled short-range wireless communication.

In this way, it is possible to perform behavior prediction processing of the user on the basis of the information for behavior prediction transmitted by the loosely coupled short-range wireless communication and realize appropriate remote control of the control object corresponding to predicted behavior.

[Thirty-seventh aspect] In the wearable device according to the thirty-sixth aspect, the communication section may transmit, as the information for behavior prediction, at least one of position information of the wearable device, environment information measured by the wearable device, and biological information of the user measured by the wearable device to the gateway device through the loosely coupled short-range wireless communication.

In this way, it is possible to perform behavior prediction processing reflecting the position information of the wearable device, the environment information, or the biological information of the user and realize appropriate remote control of the control object corresponding to predicted behavior.

[Thirty-eighth aspect] In the wearable device according to any one of the thirty-fourth to thirty seventh aspects, the loosely coupled short-range wireless communication may be communication performed in a scan period in which the gateway device searches for a presence notification packet transmitted from the wearable device.

[Thirty-ninth aspect] In the wearable device according to the thirty-eighth aspect, the communication section may transmit information to the gateway device using the presence notification packet or, when the gateway device transmits a request packet in response to the presence notification packet, transmit information to the gateway device using a response packet to the request packet.

[Fortieth packet] In the wearable device according to the thirty-eighth or thirty-ninth aspect, the presence notification packet and the scan period may be respectively an advertising packet and an active scan period in a Bluetooth (registered trademark).

[Forth-first aspect] In the wearable device according to any one of the thirty-fourth to fortieth aspects, the communication section may perform, in a first period, the loosely coupled short-range wireless communication between the communication section and a first gateway device included in a short-range wireless communication network and perform, in a second period different from the first period, the loosely coupled short-range wireless communication between the communication section and a second gateway device included in the short-range wireless communication network.

In this way, it is possible to realize, for example, constant connection between the wearable device and the computer communication network using the loosely coupled short-range wireless communication while sequentially switching gateway devices, which are connection destinations of the wearable device.

[Forty-second aspect] In the wearable device according to any one of the thirty-fourth to forty-first aspects, the wearable device may be communicatively connected to the gateway device by the loosely coupled short-range wireless communication directly not via another information communication terminal.

In this way, it is possible to communicatively connect the wearable device to the computer communication network without requiring an information communication terminal and improve the constant connectivity and the like.

[Forth-third aspect] Still another aspect of the invention relates to a wearable device including: a processing section configured to process information; and a communication section configured to perform short-range wireless communication between the communication section and a gateway device communicatively connected to a computer communication network. The communication section is communicatively connected to the computer communication network via the gateway device by performing the short-range wireless communication with the gateway device in a scan period in which the gateway device searches for a presence notification packet transmitted from the wearable device. The processing section performs processing for automatically remotely controlling, with the computer communication network, a control object used by a user.

According to the other aspect of the invention, the wearable device can be communicatively connected to the computer communication network via the gateway device by the short-range wireless communication performed in the scan period in which the gateway device searches for the presence notification packet. The wearable device of the user can be communicatively connected to the computer communication network using such short-range wireless communication in the scan period. The control object used by the user can be remotely controlled. Therefore, it is possible to realize the automatic remote control of the control object using the wearable device worn by the user.

[Forth-forth aspect] In the wearable device according to the forty-third aspect, the communication section may transmit information to the gateway device using the presence notification packet or, when the gateway device transmits a request packet in response to the presence notification packet, transmit information to the gateway device using a response packet to the request packet.

[Forth-fifth aspect] In the wearable device according to the forty-third or forty-fourth aspect, the communication section may receive, in the scan period, from the computer communication network through short-range wireless communication via the gateway device, information acquired on the basis of information transmitted to the computer communication network via the gateway device.

[Forth-sixth aspect] In the wearable device according to any one of the forty-third to forth-fifth aspects, the presence notification packet and the scan period may be respectively an advertising packet and an active scan period in a Bluetooth (registered trademark).

[Forty-seventh aspect] In the wearable device according to any one of the forty-third to forty-sixth aspects, the communication section may perform, in a first period, the short-range wireless communication between the communication section and a first gateway device included in a short-range wireless communication network and perform, in a second period different from the first period, the short-range wireless communication between the communication section and a second gateway device included in the short-range wireless communication network.

[Forty-eighth aspect] Still another aspect of the invention relates to a remote control method for remotely controlling a control object used by a user wearing a wearable device, the remote control method including: communicatively connecting a wearable device to a gateway device, to which an unspecified large number of devices are connectable, through loosely coupled short-range wireless communication, the wearable device including a processing section configured to process information and a communication section configured to perform the loosely coupled short-range wireless communication between the communication section and an external device; communicatively connecting the wearable device to the computer communication network via the gateway device; and automatically remotely controlling the control object with the computer communication network.

According to the other aspect of the invention, the wearable device of the user can be communicatively connected to the computer communication network using the loosely coupled short-range wireless communication. The control object used by the user can be remotely connected. Therefore, it is possible to realize the automatic remote control of the control object using the wearable device worn by the user.

[Forth-ninth aspect] An aspect of the invention relates to a communication system including: a wearable device including a power generating section configured to generate electric power, a processing section configured to operate with the electric power supplied from the power generating section and process information, and a communication section configured to operate with the electric power supplied from the power generating section and perform loosely coupled short-range wireless communication between the communication section and an external device; and a short-range wireless communication network including a gateway device, to which an unspecified large number of devices are connectable, and connectable to a computer communication network. The wearable device is communicatively connected to the gateway device by the loosely coupled short-range wireless communication and communicatively connected to the computer communication network via the gateway device.

In the aspect of the invention, the short-range wireless communication network including the gateway device and connectable to the computer communication network is provided. The power generating section and the processing section and the communication section that operate with the electric power supplied from the power generating section are provided in the wearable device. The wearable device is communicatively connected to the gateway device by the loosely coupled short-range wireless communication and communicatively connected to the computer communication network via the gateway device. In this way, the wearable device that operates with the electric power of the power generating section can be connected to the computer communication network via the gateway device using the loosely coupled short-range wireless communication. It is possible to provide a communication system that can realize constant connectivity, a reduction in power consumption, and the like by using the loosely coupled short-range wireless communication and can improve, for example, constant connectivity of the wearable device to the computer communication network.

[Fiftieth aspect] In the communication system according to the forty-ninth aspect, the loosely coupled short-range wireless communication may be communication performed in a scan period in which the gateway device searches for a presence notification packet transmitted from the wearable device.

In this way, it is possible to realize the loosely coupled short-range wireless communication effectively utilizing the presence notification packet transmitted by the wearable device in the scan period.

[Fifty-first aspect] In the communication system according to the fiftieth aspect, the wearable device may transmit information to the gateway device using the presence notification packet or, when the gateway device transmits a request packet in response to the presence notification packet, transmit information to the gateway device using a response packet to the request packet.

In this way, information can be transmitted from the wearable device to the gateway device using the presence notification packet. Information can be transmitted from the wearable device to the gateway device using the response packet to the request packet transmitted in response to the presence notification packet.

[Fifty-second aspect] In the communication system according to the fiftieth or fifty-first aspect, the wearable device may receive, in the scan period, from the computer communication network through the loosely coupled short-range wireless communication via the gateway device, information acquired on the basis of information transmitted to the computer communication network via the gateway device.

In this way, in the scan period, when the wearable device transmits information to the computer communication network, the wearable device can receive, in the scan period, information acquired on the basis of the information. Consequently, it is possible to realize directional communication by the loosely coupled short-range wireless communication.

[Fifty-third aspect] In the communication system according to any one of the fiftieth to fifty-second aspects, the presence notification packet and the scan period may be respectively an advertising packet and an active scan period in a Bluetooth (registered trademark).

In this way, it is possible to realize the loosely coupled short-range wireless communication using the advertising packet and the active scan period in the Bluetooth.

[Fifty-Fourth Aspect]

In the communication system according to any one of the forty-ninth to fifty-third aspects, the wearable device may perform, in a first period, the loosely coupled short-range wireless communication between the wearable device and a first gateway device included in the short-range wireless communication network and perform, in a second period different from the first period, the loosely coupled short-range wireless communication between the wearable device and a second gateway device included in the short-range wireless communication network.

In this way, it is possible to realize, for example, constant connection between the wearable device and the computer communication network using the loosely coupled short-range wireless communication while sequentially switching gateway devices, which are connection destinations of the wearable device.

[Fifty-fifth aspect] In the communication system according to the fifty-fourth aspect, when the wearable device is communicatively connected to the second gateway device and a given deletion condition is satisfied, the first gateway device may perform deletion processing of reception information from the wearable device or transmission information to the wearable device.

In this way, it is possible to prevent the reception information and the transmission information from being uselessly stored in a storing section of the first gateway device and achieve saving of a storage capacity in use of the storing section.

[Fifty-sixth aspect] In the communication system according to any one of the forty-ninth to fifty-fifth aspect, the gateway device may perform processing for converting address information of the wearable device received from the wearable device by the loosely coupled short-range wireless communication into address information for the computer communication network.

In this way, it is possible to uniquely specify the wearable device on the computer communication network using the address information for the computer communication network converted from the address information of the wearable device.

[Fifty-seventh aspect] In the communication system according to any one of the forty-ninth to fifty-sixth aspect, the wearable device may be communicatively connected to the gateway device by the loosely coupled short-range wireless communication directly not via another information communication terminal.

In this way, it is possible to communicatively connect the wearable device to the computer communication network without requiring an information communication terminal and improve the constant connectivity and the like.

[Fifty-eighth aspect] In the communication system according to any one of the forty-ninth to fifty-seventh aspects, the communication system may include a second wearable device communicatively connected to the wearable device, and the second wearable device may be communicatively connected to the computer communication network by the loosely coupled short-range wireless communication via the wearable device and the gateway device.

In this way, the second wearable device can be communicatively connected to the gateway device using the wearable device as a relay device. Therefore, it is easy to perform communicative connection to, for example, a gateway device at a long distance.

[Fifty-ninth aspect] In the communication system according to the fifty-eighth aspect, when a given deletion condition is satisfied, the wearable device may perform deletion processing of reception information from the second wearable device or transmission information to the second wearable device.

In this way, it is possible to prevent a situation in which the reception information and the transmission information concerning the second wearable device are uselessly stored in a storing section of the wearable device functioning as the relay device.

[Sixtieth aspect] In the communication system according to any one of the forty-ninth to fifty-ninth aspects, the loosely coupled short-range wireless communication between the wearable device and the gateway device may be set to connection or nonconnection on the basis of input information input from the user.

In this way, it is possible to temporarily disconnect constant connection according to selection of the user. It is possible to improve convenience and the like.

[Sixty-first aspect] In the communication system according to any one of the forty-ninth to sixtieth aspects, the power generating section may include a solar cell, and average power consumption of the wearable device may be set to electric power equal to or smaller than electric power generated by the power generating section under an environment of illuminance of 500 lux.

In this way, only with generated power of the power generating section under a condition assumed to be lower limit illuminance, it is possible to realize, for example, constant connection to the computer communication network by the loosely coupled short-range wireless communication while operating the wearable device.

[Sixty-second aspect] In the communication system according to any one of the forty-ninth to sixtieth aspects, the power generating section may perform at least one power generation of vibration power generation, hand-wound power generation, and temperature-difference power generation.

However, the power generation of the power generating section is not limited to these kinds of power generation.

[Sixty-third aspect] In the communication system according to any one of the forty-ninth to sixty-second aspects, the information communicated by the loosely coupled short-range wireless communication may include at least one of biological information of the user wearing the wearable device and time information.

In this way, it is possible to communicate the biological information of the user and the time information using the loosely coupled short-range wireless communication.

[Sixty-fourth aspect] Still another aspect of the invention relates to a short-range wireless communication network used in the communication system according to any one of the forty-ninth to sixty-third aspects.

[Sixth-fifth aspect] Still another aspect of the invention relates to a wearable device including: a power generating section configured to generate electric power; a processing section configured to operate with the electric power supplied from the power generating section and process information; and a communication section configured to operate with the electric power supplied from the power generating section and perform loosely coupled short-range wireless communication between the communication section and an external device. The communication section is communicatively connected to a gateway device, to which an unspecified large number of devices are connectable, by the loosely coupled short-range wireless communication and communicatively connected to the computer communication network via the gateway device.

According to the other aspect of the invention, the wearable device that operates with the electric power of the power generating section can be communicatively connected to the computer communication network via the gateway device using the loosely coupled short-range wireless communication. It is possible to achieve improvement of constant connectivity and the like of the wearable device.

[Sixty-sixth aspect] In the wearable device according to the sixty-fifth aspect, the loosely coupled short-range wireless communication is communication performed in a scan period in which the gateway device searches for a presence notification packet transmitted from the wearable device.

[Sixty-seventh aspect] Still another aspect of the invention relates to a wearable device including: a power generating section configured to generate electric power; a processing section configured to operate with the electric power supplied from the power generating section and process information; and a communication section configured to operate with the electric power supplied from the power generating section and perform short-range wireless communication between the communication section and a gateway device communicatively connected to a computer communication network. The communication section is communicatively connected to the computer communication network via the gateway device by performing the short-range wireless communication with the gateway device in a scan period in which the gateway device searches for a presence notification packet transmitted from a wearable device.

According to the other aspect of the invention, the wearable device that operates with the electric power of the power generating section can be communicatively connected to the computer communication network via the gateway device by the short-range wireless communication performed in the scan period in which the gateway device searches for the presence notification packet. It is possible to achieve improvement of constant connectivity and the like of the wearable device.

[Sixth-eighth aspect] In the wearable device according to the sixty-seventh aspect, the communication section may transmit information to the gateway device using the presence notification packet or, when the gateway device transmits a request packet in response with the presence notification packet, transmit information to the gateway device using a response packet to the request packet.

[Sixty-ninth aspect] In the wearable device according to the sixty-seventh or sixty-eighth aspect, the communication section may receive, in the scan period, from the computer communication network through short-range wireless communication via the gateway device, information acquired on the basis of information transmitted to the computer communication network via the gateway device.

[Seventieth aspect] In the wearable device according to the sixty-seventh or sixty-ninth aspect, the presence notification packet and the scan period may be respectively an advertising packet and an active scan period in a Bluetooth (registered trademark).

[Seventy-first aspect] In the wearable device according to the sixty-seventh or seventieth aspect, the communication section may perform, in a first period, the short-range wireless communication between the communication section and a first gateway device included in a short-range wireless communication network and perform, in a second period different from the first period, the short-range wireless communication between the communication section and a second gateway device included in the short-range wireless communication network.

### BRIEF DESCRIPTION OF THE DRAWINGS

FIG. 1 a diagram showing an overall configuration example of a communication system (a control system) in an embodiment.

FIG. 2 is a configuration example of a wearable device, a gateway device, and a server.

FIG. 3A is an explanatory diagram of a method of a comparative example of the embodiment.

FIG. 3B is an explanatory diagram of a method of a comparative example of the embodiment.

FIG. 4A is an explanatory diagram of a communication method in the embodiment.

FIG. 4B is an explanatory diagram of a communication method in the embodiment.

FIG. 5 is a communication sequence chart from standby until pairing.

FIG. 6 is a communication sequence chart for explaining loosely coupled short-range wireless communication in the embodiment.

FIG. 7A is an explanatory diagram of a packet format, a request packet, and a response packet.

FIG. 7B is an explanatory diagram of a packet format, a request packet, and a response packet.

FIG. 8A is an explanatory diagram of a method of sequentially switching gateway devices set as connection destinations of the wearable device and performing communication.

FIG. 8B is an explanatory diagram of the method of sequentially switching gateway devices set as connection destinations of the wearable device and performing communication.

FIG. 8C is an explanatory diagram of the method of sequentially switching gateway devices set as connection destinations of the wearable device and performing communication.

FIG. 9A is an explanatory diagram of a method of performing communication via another wearable device.

FIG. 9B is an explanatory diagram of the method of performing communication via another wearable device.

FIG. 10A is an explanatory diagram of a method of setting the loosely coupled short-range wireless communication to connection and nonconnection.

FIG. 10B is a configuration example of a power generating section.

FIG. 11A is an explanatory diagram of notification processing and monitoring processing in which the loosely coupled short-range wireless communication is used.

FIG. 11B is an explanatory diagram of the notification processing and the monitoring processing in which the loosely coupled short-range wireless communication is used.

FIG. 12A is a specific example of the notification processing.

FIG. 12B is a specific example of the notification processing.

FIG. 12C is a specific example of the notification processing.

FIG. 13A is an example of statistical information and log information acquired on the basis of monitoring processing of the wearable device.

FIG. 13B is an example of statistical information and log information acquired on the basis of the monitoring processing of the wearable device.

FIG. 14 is a configuration example of a watch, which is a wearable device.

FIG. 15A is a configuration example of a motor, a hand movement mechanism, and a motor driving circuit.

FIG. 15B is a configuration example of the motor, the hand movement mechanism, and the motor driving circuit.

FIG. 16A is an explanatory diagram of a driving method for the motor.

FIG. 16B is an explanatory diagram of the driving method for the motor.

FIG. 17 is a flowchart of processing for acquiring statistical information on the basis of the monitoring processing.

FIG. 18 is an example of log information acquired on the basis of the monitoring processing.

FIG. 19 is an explanatory diagram of a remote control method for a control object based on information transmitted by the loosely coupled short-range wireless communication.

FIG. 20 is a configuration example of a server and a control target device.

FIG. 21A is an explanatory diagram of authentication processing and behavior prediction processing based on information for authentication and information for behavior prediction transmitted by the loosely coupled short-range wireless communication.

FIG. 21B is an explanatory diagram of the authentication processing and the behavior prediction processing based on the information for authentication and the information for behavior prediction transmitted by the loosely coupled short-range wireless communication.

FIG. 22 is an example of user information.

FIG. 23A is an explanatory diagram of a remote control method for the control object based on behavior prediction processing for a user.

FIG. 23B is an explanatory diagram of the remote control method for the control object based on the behavior prediction processing for the user.

FIG. 23C is an explanatory diagram of the remote control method for the control object based on the behavior prediction processing for the user.

FIG. 24A is an explanatory diagram of a detailed example of the behavior prediction processing.

FIG. 24B is an explanatory diagram of a detailed example of the behavior prediction processing.

FIG. 25A is a configuration example of an elevator and a robot, which are control target devices.

FIG. 25B is a configuration example of an elevator and a robot, which are control target devices.

### DESCRIPTION OF EMBODIMENTS

A preferred embodiment of the invention is explained in detail blow. Note that the embodiment explained below does not unduly limit the content of the invention described in the claims. Not all of components explained in this embodiment are essential as solutions of the invention.

### 1. Overall Configuration

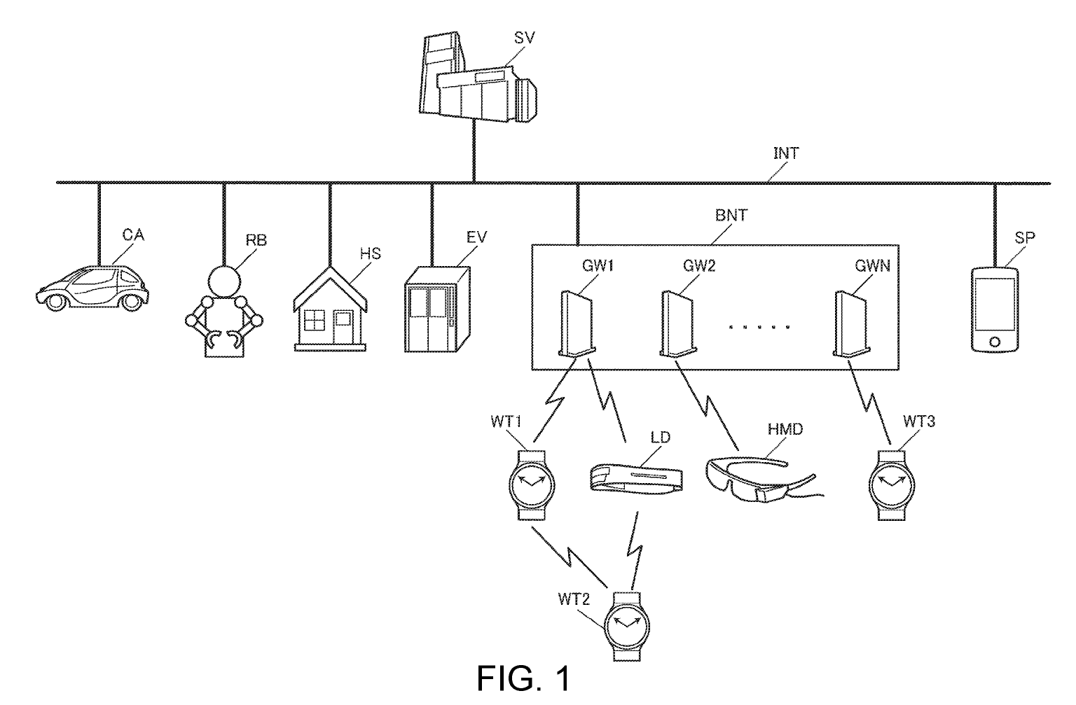

An overall configuration example of a communication system (a control system) in this embodiment is shown in FIG. 1. As shown in FIG. 1, the communication system (the control system) in this embodiment includes wearable devices (watches WT1 to WT3, a biological sensor device LD, and a head-mounted display device HMD), a short-range wireless communication network BNT, and a computer communication network INT. The communication system (the control system) can include a server SV and control objects (an elevator EV, a smart house HS, a robot RB, and an automobile CA).

The computer communication network INT is, for example, the Internet, which is a network based on the communication standard of TCP/IP. The computer communication network INT is, for example, a network on which computers can be individually identified by unique IP addresses. The computer communication network INT is, for example, a wide area network (WAN) to which the server SV is communicatively connectable. The computer communication network INT can include communication networks such as a cable network, a telephone communication network, and a wireless LAN. A communication method may be either wired or wireless.

The short-range wireless communication network BNT is a communication network including gateway devices GW1 to GWN (access points) and connectable to the computer communication network INT. The gateway devices GW1 to GWN are, for example, devices to which an unspecified large number of devices (devices carried by an unspecified large number of users) are connectable. As the short-range wireless communication network BNT, for example, a communication network of a Bluetooth (registered trademark) can be used. For example, the gateway devices GW1 to GWN can be realized by routers of the Bluetooth. The short-range wireless communication network BNT may be a communication network formed in a geographically distant wide region like a WAN or may be a communication network formed in a specific premise like a LAN. For example, the short-range wireless communication network BNT may be a communication network formed in a premise such as an amusement facility, a shopping mall, a company, or a factory.

As the short-range wireless communication network BNT, communication networks by ZigBee (registered trademark), Wi-Sun (registered trademark), IP500 (registered trademark), and the like can also be used.

The ZigBee is a wireless standard for operation with saved power, the specifications of which are defined by a ZigBee alliance. The ZigBee operates on IEEE 802.15.4. As nodes of the ZigBee, three types of a coordinator, a router, and an end device are defined. As basic operations of the ZigBee, the end device usually sleeps in power saving, wakes up with a trigger signal from a timer, sends data to the router or the coordinator, and shifts to the sleep again. The end device shifts to the sleep to achieve power saving of the end device. On the other hand, the router and the coordinator always stay on standby in a reception state and wait for data from the end device.

The Wi-SUN is a wireless communication standard for mounting terminals on, for example, gas, electricity, and water meters and efficiently collecting data using wireless communication. In the Wi-SUN, communication is performed with a radio wave in a frequency band around 900 MHz called sub-gigahertz band. Therefore, the Wi-SUN has a characteristic that a radio wave easily reaches even if an obstacle and the like are present and interference from other devices and the like is less compared with a short-range wireless communication in a 2.4 GHz band. The specifications of a physical layer of the Wi-SUN are standardized by IEEE 802.15.4g. A plurality of terminals relay data in a bucket brigade manner. The Wi-SUN is also adapted to multi-hop communication that connects remote places.

The IP500 adopts IEEE 802.15.4 in a physical layer and performs communication using the sub-gigahertz band. A mesh network is a basic network. Full mutual connection with an existing network is possible. The IP500 is also adapted to IPv6 and 6LoWPAN.

In FIG. 1, as wearable devices, the watches WT1, WT2, and WT3 (wristwatches), the biological sensor device LD of a wrist type, and the head-mounted display device HMD are communicatively connected to the short-range wireless communication network BNT (the gateway devices GW1, GW2, and GWN).

The watches WT1 to WT3 are wrist-type electronic devices and are called, for example, GPS built-in watch, smart watch, diver's watch, or solar watch. The watches WT1 to WT3 include hand movement mechanisms such as hands (second hands, minute hands, and hour hands). The watches WT1 to WT3 include various sensors such as position sensors (GPSs, etc.), environment sensors (sensors for temperature, humidity, air pressure, terrestrial magnetism, weather, or the like), body motion sensors (acceleration sensors, gyro sensors, etc.), or biological sensors that detect biological information.

The biological sensor device LD is a wearable device capable of detecting biological information such as a pulse, an activity amount, a blood pressure, oxygen saturation, a body temperature, or biological potential. Specifically, the biological sensor device LD is a wrist-type electronic device (a wrist-type biological sensor) and is a pulse wave meter, an activity meter, or the like of a wrist type. The head-mounted display device HMD is a display device worn on the head by a user. The head-mounted display device HMD may be a non-transmission type that completely covers the eyes of the user or may be a transmission type (an eyeglass type, etc.). The sensor such as the position sensor, the environment sensor, the body motion sensor, or the biological sensor can be provided in the head-mounted display device HMD as well.

Note that, in FIG. 1, the watch WT2 is communicatively connected to the gateway device GW1 of the short-range wireless communication network BNT via the watch WT1 and the biological sensor device LD. This communicative connection can be realized by, for example, a piconet explained below. The wearable device (in a broad sense, an electronic device) in this embodiment is not limited to the device illustrated in FIG. 1. For example, as the wearable device in this embodiment, various devices wearable on various parts (the chest, the abdomen, the foot, the neck, a finger, etc.) of the user besides the hand and the head can be assumed.

In FIG. 1, as the control objects (control target devices), the elevator EV, the smart house HS, the robot RB, and the automobile CA are communicatively connected to the computer communication network INT.

The elevator EV is an elevator provided in a company, a facility, a private house, or the like. The smart house HS is a house in which household electric appliances and equipment are communicatively connected by intelligent wires and the like to perform optimized control. For example, in the smart house HS, household electric appliances, a solar power generator, a storage battery, an electric automobile, and the like are centrally managed by an energy management system for home use called HEMS (Home Energy Management System). The robot RB is, for example, a robot of a double arm type or a single arm type. The robot RB may be an industrial robot used in a factory or the like or may be a robot for non-industrial use (medical, welfare, security, communication, or entertainment use). The automobile CA is, for example, a car of an internal combustion engine type, a hybrid car, an electric automobile, or a fuel battery car. The automobile CA may be a two-wheeled vehicle such as a motorbike.

As explained below, the elevator EV, the smart house HS, the robot RB, and the automobile CA are remotely controlled via the computer communication network INT such as the Internet using loosely coupled short-range wireless communication of wearable devices and gateway devices.

Note that control objects of the remote control are not limited to those shown in FIG. 1. Various apparatuses and equipment can be assumed. A portable information communication terminal SP (a smartphone, a cellular phone, a tablet PC, etc.) carried by the user of the wearable device is also communicatively connected to the computer communication network INT. For example, notification processing to the user may be realized using a display section, a sound output section, and the like of the information communication terminal SP.

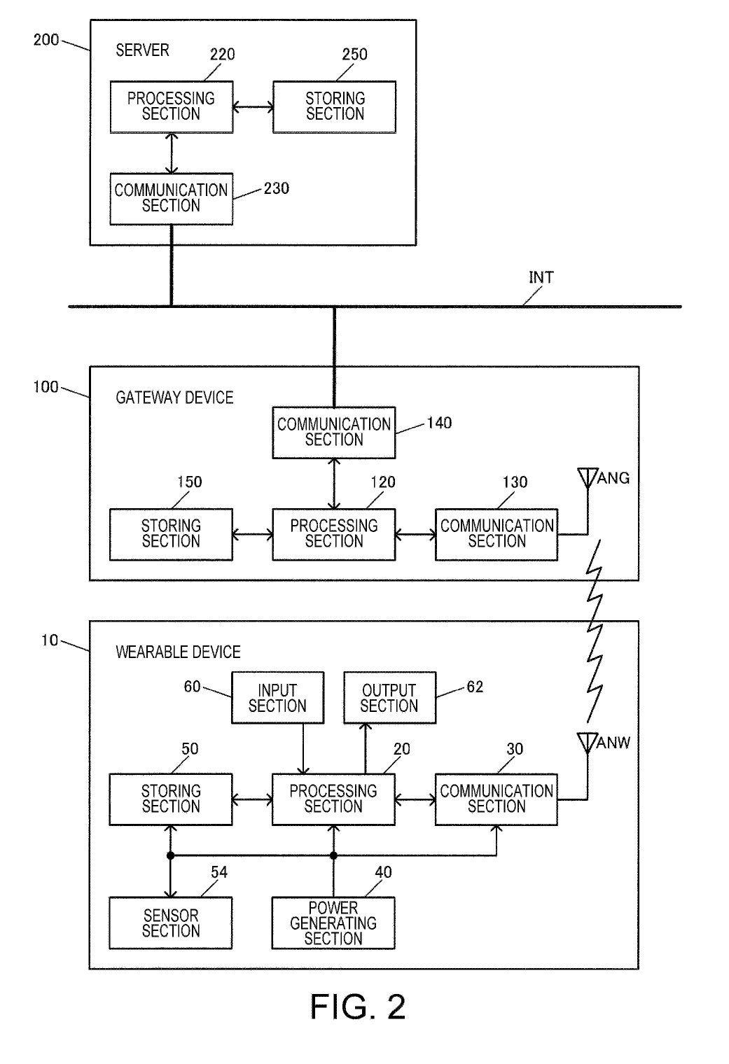

A configuration example of a wearable device 10 (the watches WT1 to WT3, the biological sensor device LD, and the head-mounted display device HMD), a gateway device 100 (GW1 to GWN), and a server 200 (SV) in this embodiment is shown in FIG. 2.

The wearable device 10 includes a processing section 20 and a communication section 30. The wearable device 10 can include a power generating section 40, a storing section 50, a sensor section 54, an input section 60, and an output section 62. The gateway device 100 includes a processing section 120, communication sections 130 and 140, and a storing section 150. The server 200 includes a processing section 220, a communication section 230, and a storing section 250.

Note that the configurations of the wearable device 10, the gateway device 100, and the server 200 are not limited to configurations shown in FIG. 2. Various modified implementations are possible. For example, a part of the components can be omitted, other components can be added, and a connection relation can be changed.

The processing sections 20, 120, and 220 (processors) are sections that perform processing and control of various kinds of information. Respective kinds of processing (functions) in this embodiment performed by the respective processing sections 20, 120, and 220 can be realized by processors (processors including hardware). For example, the respective kinds of processing in this embodiment can be realized by processors that operate on the basis of information such as programs and memories (the storing sections 50, 150, and 250) that store the information such as the programs. In the processors, for example, functions of the sections may be realized by individual hardware or may be realized by integrated hardware. The processors may be, for example, CPUs (Central Processing Units). However, the processors are not limited to the CPUs. Various processors such as GPUs (Graphics Processing Units) or DSPs (Digital Processing Units) can be used. The processors may be hardware circuits by ASICs.

The storing sections 50, 150, and 250 (memories) may be semiconductor memories such as SRAMs or DRAMS or may be registers. Alternatively, the storing sections 50, 150, and 250 may be magnetic storage devices such as hard disk devices (HDDs) or may be optical storage devices such as optical disk devices. For example, the memories have stored therein computer-readable commands. The commands are executed by the processors, whereby the processing (the functions) of the respective processing sections 20, 120, and 220 is realized. The commands may be command sets configuring programs or may be commands for instructing operations to the hardware circuits of the processors.

The communication sections 30 and 130 are circuits (ICs) that perform the short-range wireless communication of the short-range wireless communication network BNT shown in FIG. 1 using antennas ANW and ANG. The communication sections 30 and 130 are circuits that perform short-range wireless communication of various standards such as the Bluetooth, the ZigBee, or the Wi-SUN explained above. The communication sections 30 and 130 can be realized by hardware such as ASICs for communication or processors for communication, firmware for communication, or the like. Specifically, the communication sections 30 and 130 include, for example, physical layer circuits and logic circuits that realize link layer circuits. The physical layer circuits include reception circuits and transmission circuits. The reception circuits include low-noise amplifiers that amplify, with low noise, RF reception signals from the antennas ANW and ANG, mixers, and filters. The transmission circuits include power amplifiers that output transmission signals to the antennas ANW and ANG. The logic circuits can include demodulation circuits, modulation circuits, reception buffers, transmission buffers, processing circuits, and interface circuits.

The communication sections 140 and 230 perform processing of communication performed using the computer communication network INT such as the Internet. The communication sections 140 and 230 can be realized by hardware such as ASICs for communication or processors for communication, firmware for communication, or the like. For example, the communication sections 140 and 230 perform processing of communication conforming to the specifications of the Ethernet (registered trademark) as processing of physical layers and data link layers. The communication sections 140 and 230 perform processing conforming to the specifications of the TCP/IP as processing of network layers and transport layers.

In this case, the processing section 120 of the gateway device 100 performs, for example, protocol conversion between a protocol (e.g., the Bluetooth) of the short-range wireless communication network BNT and a protocol (e.g., the Ethernet or the TCP/IP) of the computer communication network INT. The processing section 120 performs, for example, processing for reconfiguring a packet of the protocol of the short-range wireless communication network BNT into a packet of the protocol of the computer communication network INT or reconfiguring a packet of the protocol of the computer communication network INT into a packet of the protocol of the short-range wireless communication network BNT. The processing section 120 performs, for example, processing for converting address information (e.g., a MAC address of the Bluetooth) of the wearable device into address information (e.g., the IPv6 of the TCP/IP) for the computer communication network INT.

The storing sections 50, 150, and 250 (the memories) are sections that store various kinds of information. The storing sections 50, 150, and 250 function as, for example, work areas of the processing sections 20, 120, and 220 and the communication sections 30, 130, 140, and 230. Various kinds of information such as programs and data for realizing various kinds of processing of the processing sections 20, 120, and 220 are stored in the storing sections 50, 150, and 250. The storing sections 50, 150, and 250 can be realized by semiconductor memories (DRAMs or VRAMs), HDDs (hard disk drives), or the like.

The power generating section 40 included in the wearable device 10 generates electric power for operating the wearable device 10. The processing section 20 operates with electric power supplied from the power generating section 40 and processes information (data and signals). The communication section 30 operates with the electric power supplied from the power generating section 40 and performs loosely coupled short-range wireless communication between the communication section 30 and the gateway device 100, which is an external device. The electric power of the power generating section 40 is supplied to the storing section 50, the sensor section 54, and the like as well. The power generation of the power generating section 40 may be realized by solar power generation (a solar cell) or may be realized by vibration power generation, hand-wound power generation, temperature difference power generation, or the like.

The electric power supplied to the wearable device 10 by the power generating section 40 is not always limited to the electric power by the power generation. For example, under a condition that a battery does not need to be replaced for one year or more, the electric power supplied to the wearable device 10 may be electric power supplied from a button battery or a similar battery incorporated in a normal watch (a wrist watch). According to the invention, substantially low power consumption can be realized compared with the related art. Therefore, there is an advantage that frequent battery replacement is unnecessary even in such a case.

The sensor section 54 can include, for example, a biological sensor, a position sensor, a motion sensor, and an environment sensor. The biological sensor is a sensor that detects biological information such as a pulse (a pules wave) an activity amount, a blood pressure, a body temperature, oxygen saturation, and biological potential. For example, the biological sensor can be realized by an optical sensor or the like including a light emitting section such as an LED and a light receiving section such as a photodiode. For example, light from the light emitting section is irradiated on the skin of the wrist and reflected light having information concerning a blood flow is made incident on the light receiving section, whereby biological information such as a pulse, oxygen saturation, and a blood pressure can be detected. Calculation of an activity amount such as a consumed calorie is also possible. The position sensor is a sensor that detects the position and the like of the wearable device 10. The position sensor can be realized by a GPS or the like. The motion sensor is a sensor that detects a movement of the wearable device 10 and a movement (a movement of the body and a behavior state such as walking or running) of the user. The motion sensor can be realized by, for example, an acceleration sensor or a gyro sensor. The environment sensor is a sensor that detects an environment situation around the wearable device 10. The environment sensor can be realized by a temperature sensor, a humidity sensor, an air pressure sensor, a terrestrial magnetism sensor, or the like.

The input section 60 is a section for inputting various signals and various kinds of information. The input section 60 can be realized by, for example, an operation section including operation buttons, a sound input section such as a microphone, or a touch panel-type display. The output section 62 outputs various signals and various kinds of information. The output section 62 can be realized by, for example, a display section such as a liquid crystal display (LCD) or an organic EL display, a sound output section such as a speaker, a light emitting section such as an LED, or a vibration generating section such as a vibration motor. For example, the notification processing in this embodiment can be realized by the display section, the sound output section, the light emitting section, the vibration generating section, or the like.

### 2. Communication System

The communication system in this embodiment performs communication using the loosely coupled short-range wireless communication. A communication method in this embodiment is explained in detail below.

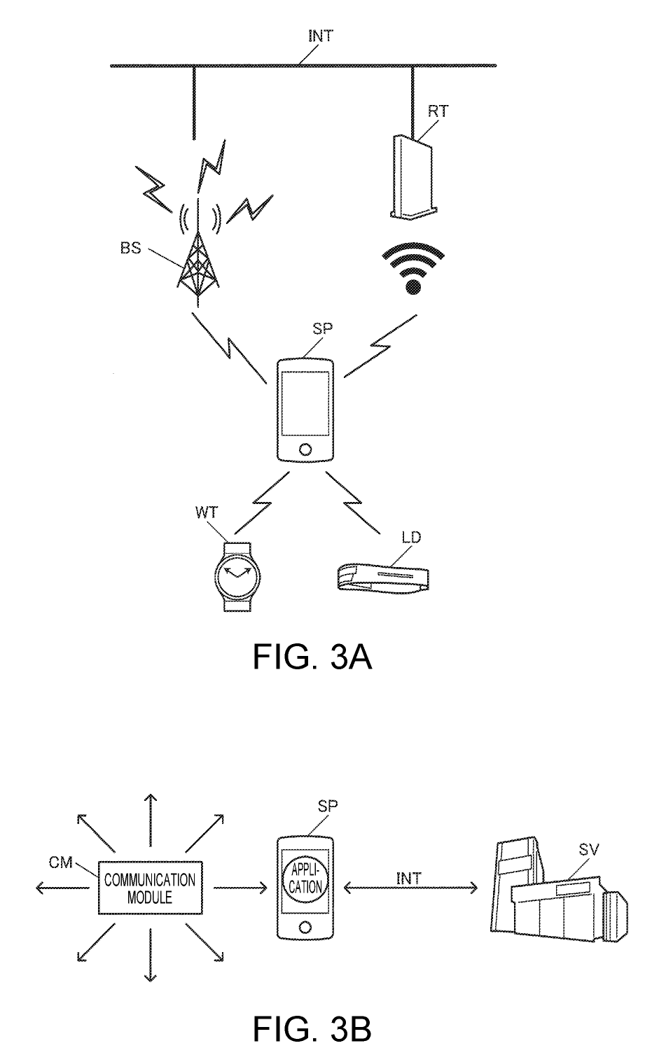

FIG. 3A and FIG. 3B are explanatory diagrams of communication methods in comparative examples of this embodiment. In a first comparative example shown in FIG. 3A, the wearable devices such as the watch WT and the biological sensor device LD are connected to the computer communication network INT such as the Internet via the portable information communication terminal SP such as a smartphone or a tablet PC. For example, the wearable devices (WT and LD) and the information communication terminal SP are connected by short-range wireless communication such as the Bluetooth. The information communication terminal SP and the computer communication network INT are connected via a base station BS and a router RT. For example, the information communication terminal SP and the base station BS are connected by a cellular phone communication network. The information communication terminal SP and the router RT are connected by a wireless communication network (a wireless LAN) such as the Wi-Fi (registered trademark). Note that, in the following explanation, the computer communication network INT is described as Internet as appropriate.

In the first comparative example shown in FIG. 3A, Internet connection for, for example, uploading information concerning the wearable devices (WT and LD) to the Internet (INT) and downloading information concerning the Internet to the wearable devices is possible. The information communication terminal SP is necessary for the connection of the wearable devices to the Internet. However, in general, the information communication terminal SP is larger than the wearable devices. The user sometimes does not always carry the information communication terminal SP. In that case, the wearable device alone cannot be connected to the Internet. In general, the information communication terminal SP has higher power consumption than the wearable devices and is sometimes out of battery. In that case, the information communication terminal SP cannot be connected to the Internet. Therefore, there is a problem in that it is difficult to maintain constant connection of the wearable devices to the Internet.

For example, to acquire life log information such as biological information and activity information of the user measuredby the wearable devices, it is desirable to constantly connect the wearable devices always worn by the user to the network. However, it is difficult to realize the constant connection in the comparative example shown in FIG. 3A. When a disaster occurs, the information communication terminal SP cannot be charged by an AC power supply because of a power failure. It is difficult to realize notification of disaster information by the wearable devices because the information communication terminal SP is out of battery.

A method of directly connecting the wearable devices to the router RT by the Wi-Fi is also conceivable. However, in this method, power consumption of communication sections of the wearable devices is excessively large. Therefore, the wearable devices need to be frequently charged. Constant wearability and constant connectivity of the wearable devices are hindered.

In the comparative example shown in FIG. 3B, for example, a communication module CM provided in a store or an amusement facility emits a beacon. When the user carrying the information communication terminal SP approaches the communication module CM, the information communication terminal SP receives the beacon. An application (an application program) corresponding to the beacon is started. The information communication terminal SP is connected to the Internet (INT) by the started application. Advertisement information of the store, guidance information of the facility, or the like is downloaded to the information communication terminal SP from the server SV.

In the comparative example shown in FIG. 3B, the information communication terminal is connected to the Internet rather than the wearable devices. The transmission of the beacon is a unidirectional communication and is not adapted to bidirectional communication. Therefore, in the comparative example shown in FIG. 3B, there is a problem in that a method of constantly connecting the Internet and the wearable devices and transmitting and receiving information cannot be realized.

In this embodiment for solving the problem explained above, a method of directly connecting the wearable devices to the computer communication network such as the Internet by the loosely coupled short-range wireless communication is adopted. Specifically, the communication system in this embodiment includes, as shown in FIG. 1 and FIG. 2, the wearable device 10 (the watches WT1 to WT3, the biological sensor device LD, and the head-mounted display device HMD) and the short-range wireless communication network BNT including the gateway device 100 (GW1 to GWN), to which an unspecified large number of devices are connectable, and connectable to the computer communication network INT. As shown in FIG. 2, the wearable device 10 includes the power generating section 40 that generates electric power, the processing section 20 that operates with the electric power supplied from the power generating section 40 and processes information, and the communication section 30 that operates with the electric power supplied from the power generating section 40 and performs the loosely coupled short-range wireless communication between the communication section 30 and an external device.

The wearable device 10 (the communication section 30) is communicatively connected to the gateway device 100 by the loosely coupled short-range wireless communication (in a broad sense, short-range wireless communication) and communicatively connected to the computer communication network INT via the gateway device 100. That is, the wearable device 10 and the gateway device 100 (e.g., a router of the Bluetooth or the like) are communicatively connected by the loosely coupled short-range wireless communication. For example, the communication section 30 of the wearable device 10 and the communication section 130 of the gateway device 100 shown in FIG. 2 perform transmission and reception of information through the loosely coupled short-range wireless communication. Taking the Bluetooth as an example, transmission and reception of information is performed by the loosely coupled short-range wireless communication before establishment of one-to-one communicative connection by pairing. The communication section 140 of the gateway device 100 performs, for example, communication conforming to the Internet protocol (the Ethernet or the TCP/IP), whereby the gateway device 100 and the computer communication network INT (the server 200) are communicatively connected. Consequently, the wearable device and the computer communication network INT are directly communicatively connected via the gateway device 100 of the short-range wireless communication network BNT.

The display section of the wearable device 10 displays information concerning the connection to the gateway device 100, that is, whether the wearable device 10 is in a connectable state or in an unconnectable state. When the wearable device 10 is stably connected, the display section visually informs the user that the user can use the Internet at ease. Note that, if the user grasps from position information of the wearable device 10 that a connectable gateway device is absent, it is also possible to achieve a reduction in power consumption by not performing communication.

For example, in the comparative example shown in FIG. 3A, the wearable devices are connected to the computer communication network INT via the information communication terminal SP. On the other hand, in the communication system in this embodiment, the wearable device 10 is communicatively connected to the gateway device 100 by the loosely coupled short-range wireless communication directly not via another information communication terminal SP and connected to the computer communication network INT. Therefore, even if the user does not carry the information communication terminal SP, the user can directly connect the wearable device 10 to the computer communication network INT. That is, the user can connect the wearable device 10 to the computer communication network INT without depending on a charging state and the like of the information communication terminal SP. The user can upload information concerning the wearable device 10 to the server 200 (SV) and download information received from the server 200 to the wearable device 10. Therefore, it is possible to constantly connect the wearable device 10 to the computer communication network INT and perform transmission and reception of information. It is possible to improve constant connectivity of the wearable device 10.

The wearable device 10 includes the power generating section 40 such as a solar power generator. The processing section 20, the communication section 30, and the like of the wearable device 10 operate with electric power supplied from the power generating section 40. Therefore, even if the wearable device 10 is not charged by an AC power supply or the like, it is possible to operate the wearable device 10 with the electric power generated by the power generating section 40. Because it is unnecessary to charge the wearable device 10 in this way, the user does not need to take off the wearable device 10 to charge the wearable device 10. It is possible to improve constant wearability of the wearable device 10.

In this case, the wearable device 10 and the gateway device 100 are connected by the loosely coupled short-range wireless communication with extremely small power consumption compared with the Wi-Fi and the like. Therefore, it is possible to operate the wearable device 10 for a long time on the basis of the electric power generated by the power generating section 40. It is possible to improve the constant wearability.

In this way, with the method in this embodiment, it is possible to greatly improve the constant connectivity and the constant wearability of the wearable device 10. Therefore, it is possible to always measure biological information and activity information (a pulse wave, a consumed calorie, a behavior history, etc.) of the user with the wearable device 10 and acquire more appropriate life log information. It is possible to provide information with a high added value to the user. For example, even when a disaster occurs, it is possible to, without being affected by a power failure and the like, inform disaster information to the user using the wearable device 10 and perform an activity for rescuing the user using position information and the like measured by the wearable device 10. Because the constant connectivity and the constant wearability of the wearable device 10 are secured, it is easy to realize notification processing of maintenance information and the like based on monitoring information and the like of the wearable device 10 explained below and remote control of a control object performed using the wearable device 10.

In the communication system according to this embodiment, because of the characteristic that the wearable device 10 can be constantly connected to the Internet without necessity of charging, in case of emergency such as a disaster, the user carrying the wearable device 10 can bidirectionally communicate with a headquarter conducted by a municipality, a police, or an army through the Internet. That is, the communication system according to this embodiment is a technique that can be utilized as an emergency response system such as a search, rescue, and evacuation guidance for sufferers even in the case of, for example, a long-term power failure in a part of a region.

The loosely coupled short-range wireless communication used in this embodiment is wireless communication with a gentle coupling degree of communication compared with normally coupled short-range wireless communication. For example, in the normally coupled short-range wireless communication, processing for establishment of communicative connection (e.g., pairing) is performed between paired two devices in bidirectional communication. When the communicative connection is once established, predetermined release processing is necessary to release the communicative connection. In such normally coupled short-range wireless communication, a protocol and the like are defined as wireless communication in a normal mode (default) in a communication standard (the Bluetooth, etc.) of a short-range wireless communication network of the normally coupled short-range wireless communication.

On the other hand, the loosely coupled short-range wireless communication is wireless communication for performing, for example, bidirectional communication between two devices with a gentle coupling degree of communication without preforming processing for establishing such communicative connection. In the loosely coupled short-range wireless communication, because the establishment of the communicative connection specified in the normally coupled short-range wireless communication is not performed, the release processing for releasing the communicative connection is unnecessary. Therefore, while switching connection target devices such as gateway devices one after another, devices such as the wearable devices can be communicatively connected to the computer communication network via the connection target devices. An example of the loosely coupled short-range wireless communication is communication performed in a preparation period before the establishment of the communicative connection. As an example of the preparation period, there is a scan period in which a search for a presence notification packet is performed. That is, the loosely coupled short-range wireless communication is, for example, communication performed in a scan period (a search period) in which the gateway device 100 searches for a presence notification packet transmitted from the wearable device 10.

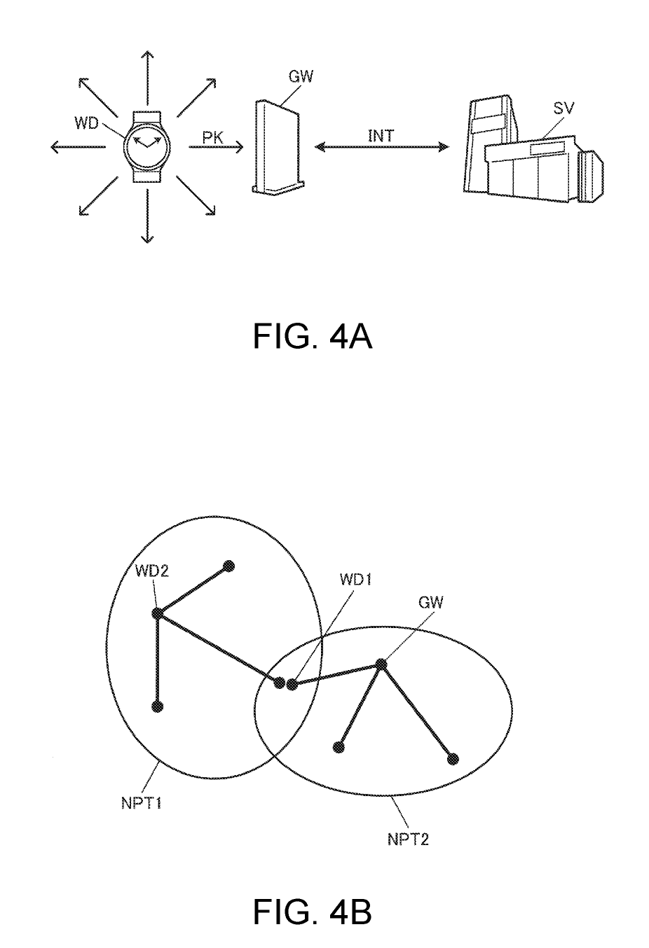

For example, in FIG. 4A, a wearable device WD performs processing for transmitting, for example, at each given cycle, a presence notification packet PK for notifying of the presence of the wearable device WD to the surroundings. The communication section 30 shown in FIG. 2 performs the transmission of the presence notification packet PK. On the other hand, the gateway device GW captures the presence notification packet PK to perform a scan operation for finding out the wearable device WD (an electronic device) present around the gateway device GW. The loosely coupled short-range wireless communication in this embodiment is such communication performed in the scan period.

That is, usually, when a wearable device around a gateway device is found in the scan period, connection establishment of communication is performed between the gateway device and the wearable device. After the connection establishment (pairing), one-to-one bidirectional communication between the gateway device and the wearable device is started.

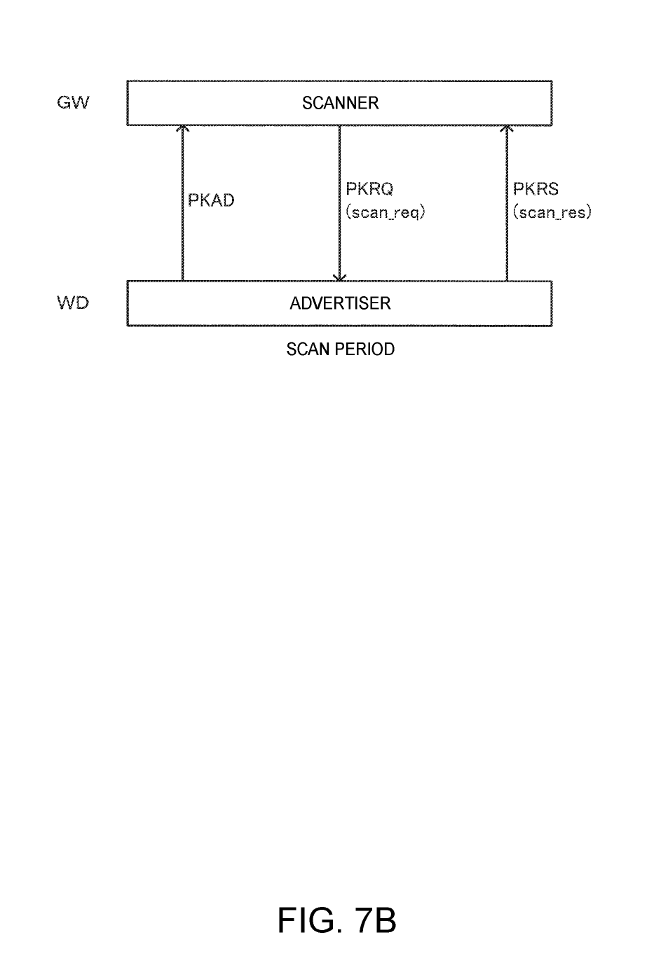

The loosely coupled short-range wireless communication in this embodiment is communication of gentle coupling performed in a scan period before such connection establishment (the pairing). For example, in this embodiment, as explained with reference to FIG. 8A to FIG. 8C referred to below, when the user wearing the wearable device moves, a gateway device in a place corresponding to the position of the user is connected to the wearable device to secure constant connectivity. That is, gateway devices set as connection destinations of the wearable device are switched one after another according to the position of the user.

In this case, when the communication between the wearable device and the gateway device is communication after the connection establishment, every time the gateway device set as the connection destination is switched, processing for releasing the connection establishment with the former gateway device and labor and time of the user are necessary. For example, it is assumed that, after connection establishment (pairing) is performed between the wearable device and a first gateway device, the user moves and the wearable device is connected to a second gateway device at a moving destination. In this case, processing for releasing the connection establishment between the wearable device and the first gateway device and operation of the user for releasing the connection establishment are necessary. Therefore, wasteful power consumption due to the releasing processing of the connection establishment occurs. A reduction in power consumption of the wearable device is interfered and convenience of the user is hindered.

In this regard, because the loosely coupled short-range wireless communication in this embodiment is the communication performed in the scan period before such connection establishment, the processing for releasing the connection establishment and the labor and time of the user are unnecessary. Therefore, it is possible to achieve a reduction in power consumption of the wearable device, improvement of convenience of the user, and the like. Because the transmission of the presence notification packet is intermittent transmission, there is also an advantage that it is possible to achieve a further reduction in power consumption, for example, according to appropriate control of a transmission interval of the presence notification packet.

Note that the wearable device 10 in this embodiment illustrated in FIG. 2 can include the processing section 20 that processes information and the communication section 30 that performs the short-range wireless communication between the communication section 30 and the gateway device 100 communicatively connected to the computer communication network INT. The communication section 30 is communicatively connected to the computer communication network INT via the gateway device 100 by performing the short-range wireless communication with the gateway device 100 in the scan period in which the gateway device 100 searches for the presence notification packet transmitted from the wearable device 10.

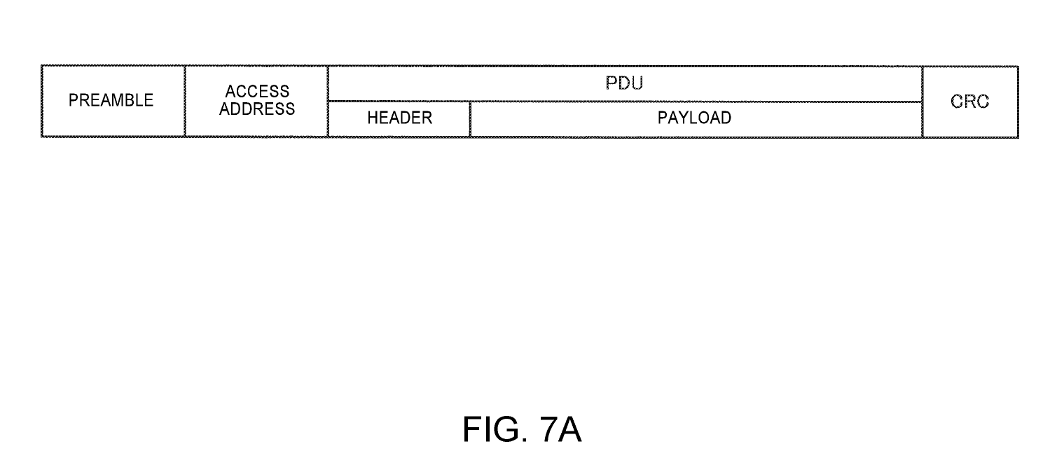

In FIG. 4A, the wearable device WD transmits information to the gateway device GW using the presence notification packet PK. For example, the wearable device WD sets transmission information in a payload (see FIG. 7A) of the presence notification packet PK to transmit the transmission information to the gateway device GW. Alternatively, as shown in FIG. 7B referred to below, when the gateway device GW transmits a request packet (PKRQ) in response to the presence notification packet PK (PKAD), the wearable device WD transmits information to the gateway device GW using a response packet (PKRS) to the request packet. For example, the wearable device WD sets transmission information in a payload (FIG. 7A) of the response packet to transmit the transmission information to the gateway device GW. This processing of the transmission is executed by the communication section 30 shown in FIG. 2. Examples of information adaptable as the transmission information include information for authentication (e.g., a device address) for authentication processing of the wearable device WD, measurement information (e.g., biological information, position information, motion information, activity amount information, or environment information such as temperature, air pressure, and humidity) of the wearable device, operation state information of devices (a motor, a power generating section, etc.) included in the wearable device, or information for remote control of a control object.

The wearable device WD receives, in the scan period, information acquired on the basis of information transmitted to the computer communication network INT via the gateway device GW. That is, in the scan period, the wearable device WD receives the information from the computer communication network INT through the loosely coupled short-range wireless communication via the gateway device GW. For example, in the scan period in which the wearable device WD transmits the transmission information to the gateway device GW, the wearable device WD receives reception information, which is information acquired on the basis of the transmission information, from the gateway device GW. The reception information is information acquired according to a result of authentication processing when the wearable device WD transmits information for the authentication processing. Alternatively, when the wearable device WD transmits measurement information of the wearable device WD and operation state information of the devices included in the wearable device WD, the reception information is information acquired on the basis of the measurement information and the operation state information. For example, the reception information is information concerning a life log obtained by the server SV processing these kinds of information, notification information, and the like. When the wearable device WD transmits information for remote control of the control object, the reception information is information acquired according to a result of the remote control.

The presence notification packet and the scan period are respectively, for example, an advertising packet and an active scan period in the Bluetooth (Bluetooth Low Energy; 4.0 or subsequent standards of the Bluetooth). The advertising packet is a packet transmitted by an advertiser for finding of a device. A scanner captures and receives the advertising packet to find the advertiser. The advertising packet is a packet transmitted by an advertising channel. In the Bluetooth, there are passive scan and active scan. In the passive scan, the scanner only receives the advertising packet. On the other hand, in the active scan, the scanner can further acquire information not fit in the advertising packet by transmitting a packet of scan_req. Not that the standard of the short-range wireless communication in this embodiment is not limited to the Bluetooth standard. Various standards such as the ZigBee standard and the Wi-SUN standard explained above or standards obtained by developing these standards can be assumed.

As explained with reference to FIG. 8A to FIG. 8C referred to below, in a first period, the wearable device WD performs the loosely coupled short-range wireless communication (in a broad sense, the short-range wireless communication) between the wearable device WD and a first gateway device GW1 included in the short-range wireless communication network BNT. In a second period different from the first period (a second period following the first period), the wearable device WD performs the loosely coupled short-range wireless communication (in a broad sense, the short-range wireless communication) between the wearable device WD and a second gateway device GW2 included in the short-range wireless communication network BNT. For example, in the first period in which the wearable device WD is located in the vicinity of the first gateway device GW1, the wearable device WD performs the loosely coupled short-range wireless communication between the wearable device WD and the first gateway device GW1. In the second period in which the wearable device WD is located in the vicinity of the second gateway device GW2, the wearable device WD performs the loosely coupled short-range wireless communication between the wearable device WD and the second gateway device GW2. That is, the wearable device WD sequentially switches, according to the position of the wearable device WD, gateway devices set as connection destinations of the loosely coupled short-range wireless communication. In this case, as shown in FIG. 8A to FIG. 8C, when the wearable device WD is communicatively connected to the second gateway device GW2 and a given deletion condition is satisfied, the first gateway device GW1 performs deletion processing of reception information from the wearable device WD or transmission information (e.g., information scheduled to be transmitted) to the wearable device WD.

The gateway device GW performs processing for converting address information of the wearable device WD received from the wearable device WD by the loosely coupled short-range wireless communication into address information for the computer communication network. The processing section 120 shown in FIG. 2 executes this conversion processing. The address information of the wearable device WD is, for example, device address information such as a MAC address of the wearable device WD. As the device address information, for example, identification information (an identification number, a manufacturing number, etc.) of a semiconductor IC for communication configuring the communication section 30 shown in FIG. 2 can be used. Alternatively, information obtained by adding given information to the identification information of the semiconductor IC may be used as the device address information. The address information for the computer communication network is identification information for uniquely specifying a device in the computer communication network INT. For example, when the computer communication network INT is the Internet, the address information for the computer communication network is an IP address. The address information for the computer communication network is, for example, an IP address specified by the IPv6 of the Internet protocol. Approximately 2³² usable IP addresses in IPv4 increases to approximately 2¹²⁸ usable IP addresses in the IPv6. In protocol conversion from the Bluetooth to the Internet protocol, the gateway device GW converts a device address (a MAC address) of the wearable device WD into, for example, an IP address conforming to the IPv6. Consequently, the wearable device WD can be identified as one and only device on the Internet.

As shown in FIG. 4A, the wearable device WD is communicatively connected to the gateway device GW by the loosely coupled short-range wireless communication directly not via another information communication terminal SP. That is, the wearable device WD is communicatively connected to the gateway device GW directly not via the information communication terminal SP such as a smartphone, a tablet PC, a cellular phone, or a notebook PC. In this way, for example, even when the user does not carry the information communication terminal SP or when the information terminal SP is, for example, out of battery, the wearable device WD can be directly connected to the computer communication network INT. It is possible to improve the constant connectivity. Because the wearable device WD and the gateway device GW are directly connected by the loosely coupled short-range wireless communication, it is possible to greatly reduce power consumption compared with when the wearable device WD and the gateway device GW are connected by the Wi-Fi or the like. It is possible to improve the constant connectivity and the constant wearability.

As shown in FIG. 4B, the communication system in this embodiment may include a second wearable device WD2 communicatively connected to the wearable device WD1. In this case, the second wearable device WD2 is communicatively connected to the computer communication network INT by the loosely coupled short-range wireless communication via a wearable device WD1 and the gateway device GW.

For example, FIG. 4B is an example of piconets of the Bluetooth. A piconet NPT1 (in a broad sense, a first network) and a piconet NPT2 (in a broad sense, a second network) are formed. In the piconet NPT1, the wearable device WD2 is an advertiser and the wearable device WD1 is a scanner. In the active scan period (in a broad sense, the scan period), the wearable device WD2, which is the advertiser, transmits an advertising packet (in a broad sense, a present notification packet) and the wearable device WD1, which is the scanner, receives the advertising packet, whereby the loosely coupled short-range wireless communication is realized between these devices. On the other hand, in the piconet NPT2, the wearable device WD1 is an advertiser and the gateway device GW is a scanner. In the active scan period, the wearable device WD1, which is the advertiser, transmits an advertising packet and the gateway device GW, which is the scanner, receives the advertising packet, whereby the loosely coupled short-range wireless communication is realized between these devices.

For example, the wearable device WD1 stores, in a storing section (the storing section 50 in FIG. 2) of the wearable device WD2, transmission information transmitted to the wearable device WD1 by the wearable device WD2 through the loosely coupled short-range wireless communication in the piconet NPT1. In the loosely coupled short-range wireless communication in the piconet NPT2, the wearable device WD1 only has to read out the transmission information stored in the storing section and transmit the transmission information to the gateway device GW. The wearable device WD1 stores, in the storing section of the wearable device WD1, reception information received by the wearable device WD1 from the gateway device GW through the loosely coupled short-range wireless communication in the piconet NPT2. In the loosely coupled short-range wireless communication in the piconet NPT1, the wearable device WD1 only has to read out the reception information stored in the storing section and transmit the reception information to the wearable device WD2.

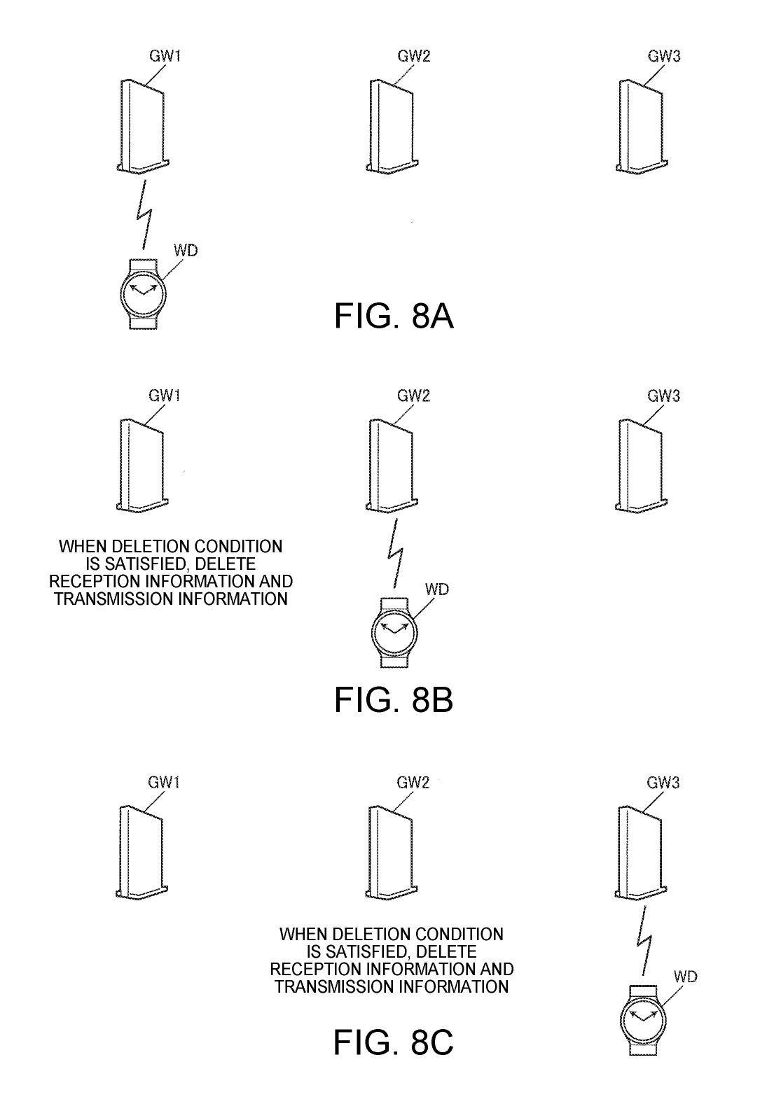

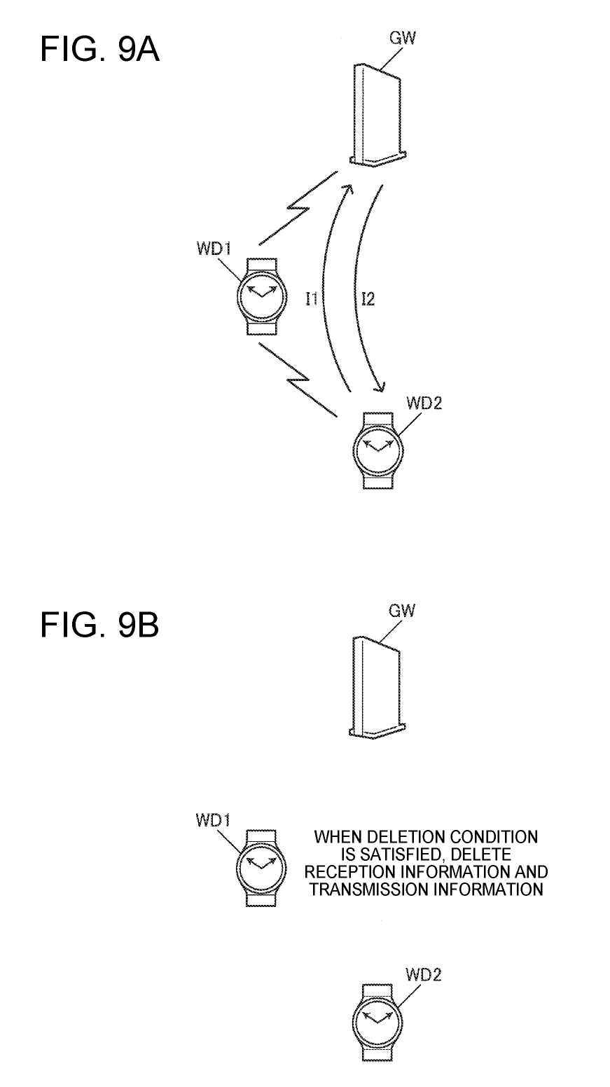

Note that, as shown in FIG. 9A and FIG. 9B referred to below, when the given deletion condition is satisfied, the wearable device WD1 desirably performs the deletion processing of the reception information from the second wearable device WD2 or the transmission information to the second wearable device WD2. As shown in FIG. 10A referred to below, the loosely coupled short-range wireless communication between the wearable device WD and the gateway device GW is desirably set to connection or nonconnection on the basis of input information from the user. The loosely coupled short-range wireless communication is set to nonconnection by the user when unnecessary in this way, leading to saving of power consumption.

The power generating section 40 shown in FIG. 2 can include a solar cell. The power generating section 40 can include, for example, a solar panel configured by the solar cell. In this case, average power consumption of the wearable device is desirably set to electric power equal to or smaller than electric power generated by the power generating section 40 under an environment of illuminance of 500 lux.

For example, illuminance at 10:00 AM in a fine day is measured as approximately 65,000 lux, illuminance by the sunlight one hour after the sunrise in a cloudy day is measured as approximately 2,000 lux, illuminance in a pachinko parlor is measured as approximately 1,000 lux, illuminance in a department store is measured as approximately 500 to 700 lux, and illuminance in an office where fluorescent lamps are use is measured as approximately 400 to 500 lux. From these measurement results, it can be assumed that lower limit illuminance around the wearable device is approximately 500 lux. Electric power generated by the power generating section under the environment of illuminance of 500 lux is represented as PWmin and average power consumption of the wearable device is represented as PWay. Then, if PWmin and PWav are set as PWavPWmin, the wearable device can be operated only by generated power of the power generating section 40 under the environment of 500 lux, which is assumed to be the lower limit illuminance. Therefore, it is possible to operate the wearable device without charging the wearable device for a long period of, for example, one year or more. It is possible to improve the constant wearability of the wearable device. As a result, it is possible to always measure biological information and activity information of the user and acquire life log information of the user.

Note that the power generating section 40 may be realized by performing at least one power generation of vibration power generation, hand-wound power generation, and temperature difference power generation. As the vibration power generation, there are a piezoelectric scheme, an electromagnetic induction scheme, and an electrostatic scheme. The piezoelectric scheme is a scheme for collecting, as electric power, a potential difference that occurs when a material (a piezoelectric element) is deformed by vibration. The electromagnetic induction scheme is a scheme for using a rotary generator or the like. Taking a wrist-type electronic device such as a watch as an example, a built-in rotary weight is rotated by a movement of an arm of the user, the rotary generator is rotated at ultrahigh speed using the rotation accelerated by a gear, and generated electric power is charged in a capacitor. In a generator of the electrostatic scheme, a structure in which two planar electrodes are opposed to each other is used and a positional relation between the opposed electrodes deviates because of vibration, whereby an electromotive force is generated. In the hand-wound power generation, a generator that generates electric power by rotating a rotary member such as a crown of a watch or a handle is used. For example, a coil wound with a lead wire is disposed between magnets and rotated to perform power generation. The temperature difference power generation is a scheme for generating electric power using a temperature difference between high temperature and low temperature. Specifically, electric power is generated using thermoelectric elements (Seebeck elements). For example, electric power is generated using a temperature difference between the body temperature of the user and the temperature of a housing (e.g., a surface side) of the wearable device.

In the Seebeck temperature different power generation, generated power is larger as a heat transfer area in which the Seebeck elements are disposed is larger. Therefore, it is desirable to dispose as large a number of Seebeck elements as possible over the entire area where the wearable device and the user (the skin, etc.) are in contact. For example, when the wearable device is a watch or the like, it is desirable to dispose the Seebeck elements on both of a surface on the user side of the housing and a surface on the user side of a band. A heat source on a high temperature side is not always limited to the body temperature of the user. With a wearable device having structure that can be worn over a heat source like a coldproof article such as a disposable warmer or heater built-in clothes that generate heat, it is possible to obtain a larger temperature difference than when body temperature is used. A power generation amount increases.

Information communicated by the loosely coupled short-range wireless communication in this embodiment can include at least one of biological information of the user wearing the wearable device and time information. For example, biological information of the user is acquired using the sensor section 54 shown in FIG. 2. Alternatively, when the wearable device is a watch or the like, clocked time information is acquired. The biological information and the time information are transmitted to the gateway device 100 by the loosely coupled short-range wireless communication. Consequently, the biological information and the time information can be uploaded to the server 200 via the gateway device 100 and the computer communication network INT. As a result, for example, the processing section 220 of the server 200 can generate life log information or the like based on, for example, the biological information of the user by performing various kinds of information processing.

### 3. Loosely Coupled Short-Range Wireless Communication

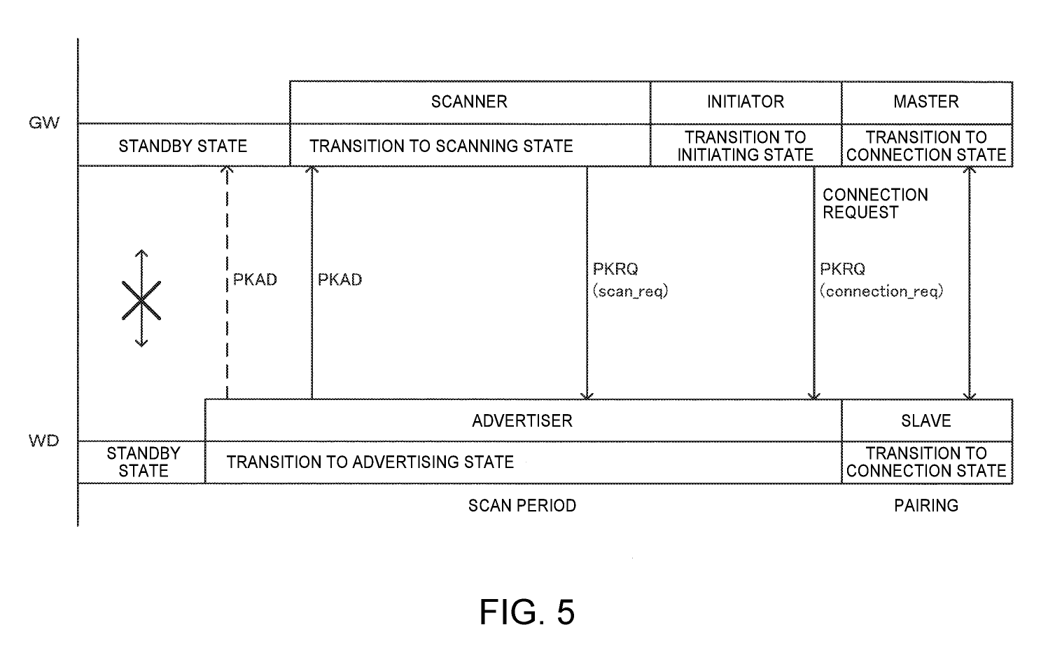

Details of the loosely coupled short-range wireless communication are explained. FIG. 5 is a communication sequence chart showing transition from standby to pairing in the Bluetooth.

First, both of the wearable device WD and the gateway device GW are in a standby state. Transmission and reception are not performed between the wearable device WD and the gateway device GW in the standby state. In FIG. 5, the wearable device WD transitions to an advertising state, functions as an advertiser (a broadcaster), and transmits the advertising packet PKAD in each fixed period. The advertising packet PKAD is a packet for the wearable device WD, which is the advertiser, notifying of the presence of the wearable device WD to the surroundings. As a transmission interval of the advertising packet PKAD is shorter, the wearable device WD is easily found. However, when the transmission interval is short, power consumption by communication increases.

When receiving the advertising packet PKAD, the gateway device GW transitions to a scanning state. In passing scan, the gateway device GW, which is a scanner (an observer), only receives the advertising packet PKAD. On the other hand, in active scan, after receiving the advertising packet PKAD, the scanner transmits the request packet PKRQ (scan_req) and acquires further information from the advertiser.

The gateway device GW determines a connection destination on the basis of the information acquired by the scan. The gateway device GW transitions to an initiating state and transmits the request packet PKRQ (connection_req) for a connection request to the wearable device WD, which is the connection destination. Consequently, the gateway device GW and the wearable device WD transition to a connection state. The gateway GW functions as a master. The wearable device WD functions as a slave. Connection establishment is performed between the master and the slave and pairing is realized. By performing the pairing in this way, one-to-one bidirectional communication is performed between the master and the slave. In the Bluetooth, reconnection, which is reconnection after the pairing, is also defined.

As shown in FIG. 5, the bidirectional communication by the Bluetooth is based on a premise that the pairing is performed. However, when such pairing is performed and the bidirectional communication is performed between a gateway device and a wearable device, there is a problem in a reduction of power consumption and constant connectivity. For example, when processing for sequentially switching gateway devices set as connection destinations of the wearable device is performed as shown in FIG. 8A to FIG. 8C referred to below, processing for releasing the pairing and the reconnection, operation of the user, and the like are necessary, electric power is wastefully consumed, and convenience of the user is hindered. Therefore, it is difficult to secure constant connection between the gateway device and the wearable device.

Therefore, in this embodiment, communicative connection between the wearable device and the gateway device is realized by the loosely coupled short-range wireless communication. The loosely coupled short-range wireless communication is communication performed in a scan period in which pairing is not performed. In FIG. 5, the scan period is a period before the request (connection_req) for the connection establishment (the connection establishment of the one-to-one bidirectional communication) is performed.

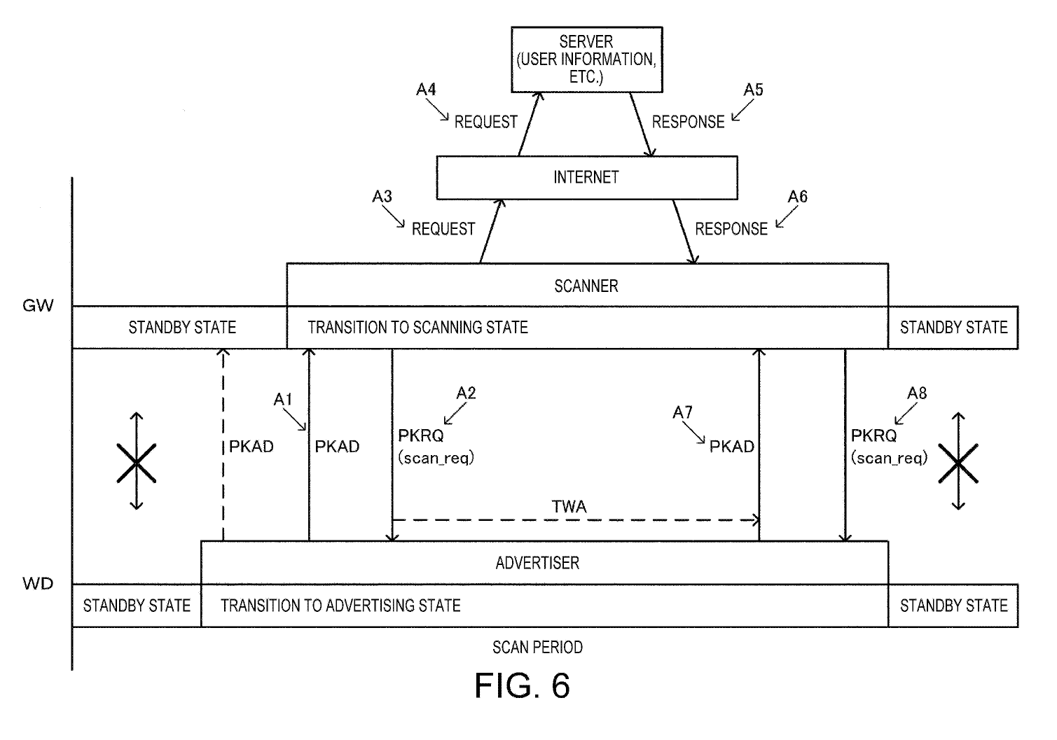

FIG. 6 is a communication sequence chart for explaining the loosely coupled short-range wireless communication in this embodiment. As shown in FIG. 6, first, the wearable device WD and the gateway device GW are in the standby state. When the wearable device WD, which has transitioned to the advertising state, transmits the advertising packet PKAD and the gateway device GW receives PKAD, the gateway device GW transitions to the scanning state.

In this case, the wearable device WD can transmit information to the gateway device GW using the advertising packet PKAD (a presence notification packet) indicated by A1 in FIG. 6. For example, the wearable device WD can transmit information for authentication such as device address information. In the active scan, the gateway device GW can acquire further information from the wearable device WD by, for example, transmitting the request packet PKRQ (scan_req) indicated by A2. For example, the gateway device GW can acquire information not fully fit in the advertising packet PKAD indicated by A1. The gateway device GW can set, using the request packet PKRQ indicated by A2, for example, the length of a period TWA for determining timing when the wearable device WD transmits the advertising packet PKAD next. In this way, it is possible to optimally control a transmission interval of the advertising packet PKAD transmitted from the wearable device WD. It is possible to achieve a further reduction in power consumption.

The gateway device GW, which has received the information for authentication and the like from the wearable device WD, delivers a request for acquiring various kinds of information such as user information present on the server to the server via the Internet (in a broad sense, the computer communication network) as indicated by A3 and A4 in FIG. 6. In this case, the gateway device GW performs protocol conversion from the Bluetooth to the Internet. The gateway device GW performs, for example, processing for converting a device address (a MAC address), which is the information for authentication received from the wearable device WD, into an IP address (IPv6) of the Internet. For example, in 4.0 or subsequent standards of the Bluetooth, the IP address of IPv6 is supported. Consequently, it is possible to uniquely specify the wearable device WD on the Internet. It is possible to specify various kinds of information such as user information associated with the IP address (the device address) in a storing section (a database).

The server returns the various kinds of information such as the user information specified in this way to the gateway device GW as a response via the Internet as indicated by A5 and A6 in FIG. 6. It is assumed that, for example, after the elapse of the period TWA, the wearable device WD transmits the advertising packet PKAD as indicated by A7. In this case, the gateway device GW transmits, for example, using the request packet PKRQ (scan_req) indicated by A8, the various kinds of information such as the user information acquired from the server to the wearable device WD. For example, the gateway device GW sets the information such as the user information in a payload of the request packet PKRQ and transmits the information. Consequently, the wearable device WD can acquire various kinds of information from the server. Note that the length of the period TWA is set considering the length of a time from the delivery of the request (A3 and A4) to the server until the return of the response (A5 and A6) from the server. At timing when the wearable device WD transmits the advertising packet PKAD after the elapse of the period TWA as indicated by A7, when a response from the server has not reached the gateway device GW, the wearable device WD may transmit the advertising packet PKAD again after a predetermined period.

In this way, in this embodiment, by using the loosely coupled short-range wireless communication shown in FIG. 6, closely coupled bidirectional communication is realized between the wearable device WD and the gateway device GW without performing the pairing shown in FIG. 5. In the loosely coupled bidirectional communication, processing such as release of the pairing and labor and time are unnecessary, it is possible to achieve a reduction in power consumption. It is possible to improve convenience of the user. For example, by optimally setting the length of the period TWA shown in FIG. 6, it is also possible to realize a further reduction in power consumption. Therefore, for example, on the basis of electric power supplied from the power generating section 40, it is possible to realize an optimal communication method in the wearable device WD that maintains constant connectivity and constant wearability without being charged and operates.

In the comparative example in which the beacon is used shown in FIG. 3B, the communication module CM itself that delivers the beacon cannot be connected to the server SV via the Internet to acquire information concerning the server SV. That is, the information concerning the server SV is acquired by the information communication terminal SP being connected to the Internet.

On the other hand, with the method of using the loosely coupled short-range wireless communication in this embodiment, as shown in FIG. 6, the wearable device WD can be communicatively connected to the gateway device GW directly not via the information communication terminal SP to acquire information from the server and the like via the Internet. Therefore, it is possible to realize a communication method optimal for constant connection and constant wearing of the wearable device WD.

Note that a bidirectional communication method between the wearable device WD and the gateway device GW is not limited to the method explained above. Various modified implementations are possible. For example, when a data amount of transmission information of the wearable device WD is large, for example, the gateway device GW transmits a plurality of times of the request packets PKRQ. The wearable device WD transmits a plurality of times of the response packets PKRS (see FIG. 7B) corresponding to these request packets PKRQ. Consequently, the transmission information can be transmitted. For example, measurement information (monitoring information) of the wearable device WD is desirably transmitted by such a transmission method. Reception information received by the wearable device WD from the gateway device GW can also be received by the same method as the transmission method explained above. The bidirectional communication between the wearable device WD and the gateway device GW may be realized using packets of packet types different from the advertising packet PKAD, the request packet PKRQ, and the response packet PKRS. For example, the bidirectional communication method in this embodiment can be realized by the standard such as 4.1 and 4.2 of the Bluetooth. However, the bidirectional communication method (the loosely coupled short-range wireless communication) in this embodiment may be realized using a packet type defined in standards obtained by developing these standards (e.g., 4.3 or subsequent standards).

A packet format of the Bluetooth is shown in FIG. 7A. A packet is configured by an access address, a protocol data unit PDU, and a cyclic check code CRC for error detection. Note that a preamble at the head of the packet is used for synchronization of the intensity of a signal and readout timing of a bit (0/1).

The access address is a random value allocated for each connection between two devices and is an identifier for distinguishing in which connection the packet is used. For example, communication of advertising is performed using three channels of the Bluetooth. An access address of the communication is set to a fixed value. Note that the advertising packet is delivered for each advertising event at a fixed cycle. A cycle of advertising can be set, for example, between 20 msec and 10.25 sec.

The PDU is data transmitted and received by an upper layer. The PDU includes a header and a payload. For example, packet types (scan_req, scan_res, connection_req, etc.) can be set by the header of the PDU.

Data by the upper layer can be set in the payload of the PDU. For example, the payload of the advertising packet includes a public device address. The public device address may be used for setting of a device address of a wearable device.

In this embodiment, as shown in FIG. 7B, the wearable device WD can transmit transmission information to the gateway device GW using the advertising packet PKAD (the presence notification packet). For example, the wearable device WD sets the transmission information in the payload of the PDU shown in FIG. 7A and transmits the transmission information. As shown in FIG. 7B, it is assumed that the gateway device GW transmits the request packet PKRQ in response to the advertising packet PKAD transmitted from the wearable device WD. In a header of the request packet PKRQ, scan_req is set as the packet type explained above. In this case, the wearable device WD may transmit the transmission information to the gateway device GW using the response packet PKRS to the request packet PKRQ. The wearable device WD transmits, using the response packet PKRS, for example, information (e.g., measurement information and monitoring information) not fit in the advertising packet PKAD. In a header of the response packet PKRS, scan_res is set as the packet type explained above. The gateway device GW can transmit, using the request packet PKRQ shown in FIG. 7B, for example, information acquired from the Internet (the server) to the wearable device WD. Note that the advertising packet PKAD, the request packet PKRQ, and the response packet PKRS have the same packet format shown in FIG. 7A.

In this embodiment, the wearable device WD sequentially switches gateway devices set as connection destinations according to the position and the like of the wearable device WD and connects the gateway device. For example, in FIG. 8A (a first period), the wearable device WD performs the loosely coupled short-range wireless communication shown in FIG. 6 between the wearable device WD and the gateway device GW1 and performs transmission and reception of information.

As shown in FIG. 8B (a second period), it is assumed that the user wearing the wearable device WD moves, the gateway device GW1 is not within a range of a communication distance, and the gateway device GW2 is within the range of the communication distance. The range of the communication distance (a range of a communicable maximum distance) is a range of, for example, approximately 50 m to 100 m in the case of the Bluetooth and the like and is a range of, for example, approximately 100 m to 1 km in the case of sub-giga communication such as the Wi-SUN. In this case, the wearable device WD performs the loosely coupled short-range wireless communication between the wearable device WD and the gateway device GW2 and performs transmission and reception of information.

When the user moves, the gateway device GW2 is not within the range of the communication distance, and the gateway device GW3 is within the range of the communication distance as shown in FIG. 8C (a third period), the wearable device WD performs the loosely coupled short-range wireless communication between the wearable device WD and the gateway device GW3 and performs transmission and reception of information.

In this way, in this embodiment, as shown in FIG. 8A to FIG. 8C, the wearable device WD sequentially switches gateway devices set as connection destinations and performs the loosely coupled short-range wireless communication. In all the cases of FIG. 8A to FIG. 8C, the wearable device WD is connected to the Internet via the gateway device. The wearable device WD can upload various kinds of information to the Internet (the server) and download information from the Internet. Therefore, it is possible to realize constant connection to the Internet. In the loosely coupled short-range wireless communication, because processing such as release of pairing is unnecessary, wasteful power consumption can be reduced. Therefore, it is possible to realize constant connection to the Internet while operating the wearable device WD with only generated power of the power generating section 40 by solar power generation or the like.

Note that, as shown in FIG. 8B, the gateway device GW1 desirably performs deletion processing of reception information from the wearable device WD and transmission information to the wearable device WD when the wearable device WD is communicatively connected to the gateway device GW2 and the deletion condition is satisfied. For example, when reception information received from the wearable device WD by the gateway device GW1 and transmission information transmitted to the wearable device WD by the gateway device GW1 are stored in a storing section of the gateway device GW1 in FIG. 8A, the gateway device GW1 deletes the reception information and the transmission information.

Similarly, as shown in FIG. 8C, when the wearable device WD is communicatively connected to the gateway device GW3 and the deletion condition is satisfied, the gateway device GW2 performs deletion processing of reception information from the wearable device WD and transmission information to the wearable device WD. For example, when reception information received from the wearable device WD by the gateway device GW2 and transmission information transmitted to the wearable device WD by the gateway device GW2 are stored in a storing section of the gateway device GW2 in FIG. 8B, the gateway device GW2 deletes the reception information and the transmission information.

The deletion condition can be determined on the basis of, for example, the elapse of time. For example, when a state changes from FIG. 8A to FIG. 8B and the gateway device GW1 cannot receive a packet transmitted from the wearable device WD, measurement of time is started. When a predetermined time elapses, the reception information and the transmission information are deleted. Alternatively, when connection of the wearable device WD to the gateway device GW2 shown in FIG. 8B is notified to the gateway device GW1 via the Internet or the like, the gateway device GW1 may delete the reception information and the transmission information stored in the storing section of the gateway device GW1.

Note that, in FIG. 6, it is assumed that, before the response (A5 and A6) is returned in response to the request (A3 and A4) delivered toward the Internet, the distance between the gateway device GW1 and the wearable device WD increases and the wearable device WD is outside the communication range. In this case, the gateway device GW1 may perform deletion processing of transmission information scheduled to be transmitted to the wearable device WD.

If the deletion processing of the reception information and the transmission information is performed in this way, it is possible to prevent a situation in which, for example, useless information is stored in a storing section of a gateway device and a storage capacity in use of the storing section is pressed. By deleing reception information and transmission information concerning an unconnected wearable device, it is possible to achieve improvement of security of information.

In this embodiment, as shown in FIG. 9A, the wearable device WD2 may be communicatively connected to the Internet (the computer communication network) by the loosely coupled short-range wireless communication via another wearable device WD1 and the gateway device GW. For example, the wearable device WD2 transmits information I1 to the gateway device GW and receives information I2 from the gateway device GW by the loosely coupled short-range wireless communication between the wearable device WD2 and the gateway device GW. The information I1 is uploaded to the Internet by the gateway device GW. The information I2 is information downloaded to the gateway device GW from the Internet. In the case of the Bluetooth, such transmission and reception of information via another wearable device can be realized by communication of piconets explained with reference to FIG. 4B.

In this case, as shown in FIG. 9B, when the deletion condition is satisfied, the wearable device WD1 desirably performs deletion processing of reception information from the wearable device WD2 and transmission information to the wearable device WD2.

For example, in FIG. 9A, it is assumed that the wearable device WD1 receives the information I1 from the wearable device WD2 and transmits the received information I1 to the gateway device GW. In this case, the wearable device WD1 once stores, in the storing section of the wearable device WD1, the information I1 received by the loosely coupled short-range wireless communication between the wearable device WD1 and the wearable device WD2. Thereafter, the wearable device WD1 transmits the information I1 stored in the storing section through the loosely coupled short-range wireless communication between the wearable device WD1 and the gateway device GW. In this case, as shown in FIG. 9B, the wearable device WD1 performs deletion processing of the information I1 temporarily stored in the storing section of the wearable device WD1.

In FIG. 9A, it is assumed that the wearable device WD1 receives the information I2 from the gateway device GW and transmits the received information I2 to the wearable device WD2. In this case, the wearable device WD1 once stores, in the storing section of the wearable device WD1, the information received by the loosely coupled short-range wireless communication between the wearable device WD1 and the gateway device GW. Thereafter, the wearable device WD1 transmits the information I2 stored in the storing section through the loosely coupled short-range wireless communication between the wearable device WD1 and the wearable device WD2. In this case, as shown in FIG. 9B, the wearable device WD2 performs deletion processing of the information I2 temporarily stored in the storing section of the wearable device WD2.

A deletion condition in this case may be determined, for example, according to the elapse of time. For example, in FIG. 9A, after the transmission of the information I1 to the gateway device GW, when a given time elapses, the wearable device WD1 deletes the information I1. Alternatively, the wearable device WD1 may delete the information I1 immediately after the transmission of the information I1. After the transmission of the information I2 to the wearable device WD2, when the given time elapses, the wearable device WD1 deletes the information I2. Alternatively, the wearable device WD may delete the information I2 immediately after the transmission of the information I2.

Note that, as shown in FIG. 9A, when the wearable device WD2 transmits the information I1 through another wearable device WD1, to ensure security, it is desirable that encryption processing of the information I1 is performed. It is desirable that the encryption processing is performed concerning the information I2 as well.

In this embodiment, the loosely coupled short-range wireless communication between the wearable device and the gateway device may be set to connection or nonconnection on the basis of input information from the user. For example, a selection screen shown in FIG. 10A is an example of a screen for the user to select connection and nonconnection of the loosely coupled short-range wireless communication with a gateway device GWA. When the user selects disconnection on the selection screen shown in FIG. 10A, the loosely coupled short-range wireless communication is not performed with the gateway device GWA.

For example, in this embodiment, as shown in FIG. 8A to FIG. 8C, a gateway device in the vicinity of the position of the user is automatically constantly connected to a wearable device of the user. However, some user does not desire such automatic constant connection. For example, the user sometimes desires to temporarily disconnect such constant connection because of a private reason or the like. In such a case, it is desirable to enable the user to disconnect the connection by the loosely coupled short-range wireless communication through, for example, the selection screen shown in FIG. 10A.

Note that, as a method of setting the loosely coupled short-range wireless communication to connection or nonconnection, various methods can be adapted. For example, without display of the selection screen shown in FIG. 10A, the user may be enabled to set connection or nonconnection of the loosely coupled short-range wireless communication with an operation section such as a switch provided in the wearable device. Alternatively, the selection screen shown in FIG. 10A may be displayed on an information communication terminal such as a smartphone carried by the user to enable the user to set connection or nonconnection of the loosely coupled short-range wireless communication.

A configuration example of the power generating section 40 is shown in FIG. 10B. FIG. 10B is a configuration example in which solar power generation is used. The power generating section 40 shown in FIG. 10B includes a solar panel 42 (a solar battery) configured by a solar cell, a charging control section 44, and a secondary battery 46 (a change storage capacitor or a battery). The solar panel 42 generates electric power with solar power generation. For example, the solar panel 42 generates electric power with incident light and outputs a generated power generation current. The charging control section 44 supplies the electric power generated by the solar panel 42 or electric power stored in the secondary battery 46 to the processing section 20, the communication section 30, and the like. The charging control section 44 charges the secondary battery 46 with the electric power generated by the solar panel 42. For example, the charging control section 44 charges the secondary battery 46 with the power generation current output from the solar panel 42.

By providing the power generating section 40 shown in FIG. 10B in the wearable device, it is possible to realize the processing section 20 that operates with the electric power supplied from the power generating section 40 and processes information and the communication section 30 that performs the loosely coupled short-range wireless communication between the communication section 30 and an external device.

The power generating section 40 shown in FIG. 10B includes the solar panel 42 (the solar cell). As explained above, the average power consumption PWav of the wearable device is set to the electric power equal to or smaller than the electric power generated by the power generating section 40 under the environment of illuminance of 500 lux. For example, as explained above, it can be assumed that the lower limit illuminance around the wearable device is approximately 500 lux. Therefore, when electric power generated by the power generating section 40 under the environment of illuminance of 500 lux is represented as PWmin, by setting PWav and PWmin as PWavPWmin, it is possible to operate the wearable device only with the generated power of the power generating section 40 under the environment of illuminance of 500 lux assumed to be the lower limit illuminance.

For example, in a wearable device such as a wrist-type electronic device (a watch such as a smart watch, a pulse meter of a wrist type, or an activity meter) in the past, the device alone cannot be connected to the Internet for a long period without being charged. On the other hand, in this embodiment, because the wearable device can be connected to the Internet by the loose coupling, power consumption can be reduced. Therefore, with only the generated power by the power generating section 40, it is possible to connect the wearable device to the Internet for a long period without charging the wearable device. The user does not have to carry both of the wearable device and the information communication terminal. It is possible to achieve improvement of convenience of the user.

### 4. Notification Processing and Monitoring Processing

Various application examples in which the communication system in this embodiment is used is explained. In this embodiment, notification processing and monitoring processing in which the loosely coupled short-range wireless communication is used are realized. For example, notification processing of notification information acquired on the basis of transmission of information concerning a wearable device by the loosely coupled short-range wireless communication is performed. Monitoring information concerning an operation state of the wearable device and an environment of use is transmitted by the loosely coupled short-range wireless communication.

Specifically, as explained with reference to FIG. 1 and FIG. 2, the wearable device 10 in this embodiment includes the processing section 20 that processes information and the communication section 30 that performs the loosely coupled short-range wireless communication between the communication section 30 and an external device. The communication section 30 is communicatively connected to the gateway device 100, to which an unspecified large umber of devices are connectable, by the loosely coupled short-range wireless communication and communicatively connected to the computer communication network INT via the gateway device 100. The processing section performs notification processing of notification information acquired on the basis of transmission of information concerning the wearable device 10 by the loosely coupled short-range wireless communication.

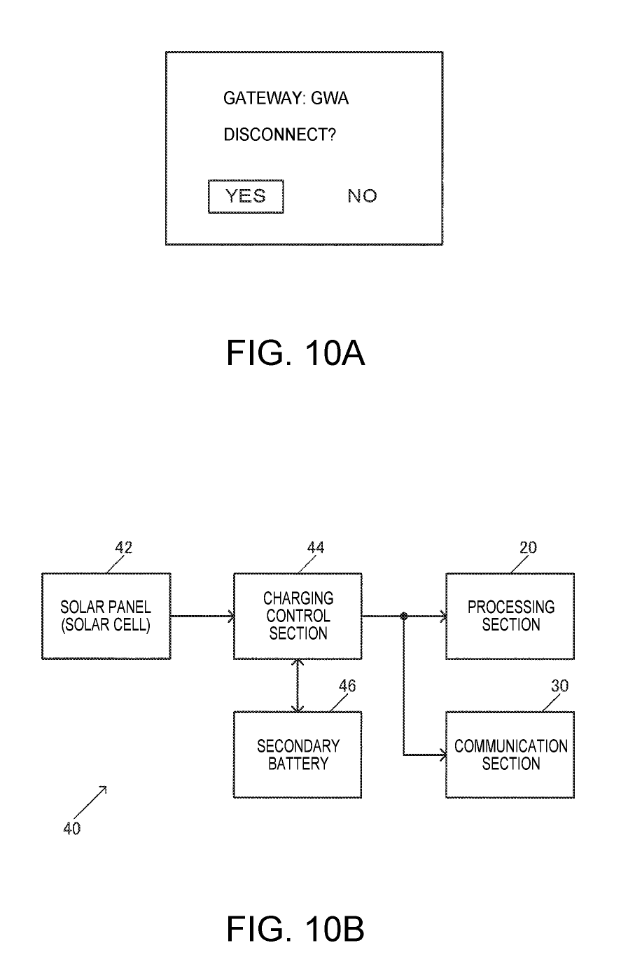

For example, in FIG. 11A, information concerning the wearable device WD is transmitted to the gateway device GW by the loosely coupled short-range wireless communication explained with reference to FIG. 6. The information is transmitted from the gateway device GW to the server SV via the Internet. The server SV performs, for example, generation processing of notification information on the basis of the information. The generated notification information is transmitted to the gateway device GW. The notification information is transmitted to the wearable device WD by the loosely coupled short-range wireless communication. Notification processing of the notification information is performed in the wearable device WD. Note that the notification information may be displayed using a display section of an information communication terminal of a user carrying the wearable device WD.

In FIG. 11B, the communication section 30 of the wearable device WD transmits, as information concerning the wearable device WD, monitoring information concerning at least one of an operation state and an environment of use of the wearable device WD to the gateway device GW through the loosely coupled short-range wireless communication.

The monitoring information concerning the operation state of the wearable device is, for example, monitoring information concerning operations (operations of a circuit, a sensor, and an element) of devices (the circuit, the sensor, the element, etc.) included in the wearable device and monitoring information concerning a physical quantity such as an electric current, a voltage, or magnetism generated in the wearable device. The monitoring information concerning the environment of use of the wearable device is monitoring information concerning an external environment and an internal environment of the wearable device. For example, the monitoring information concerning the environment of use is information including at least one of magnetic field information, temperature information, humidity information, air pressure information, magnetism information, weather information, gravity information, acceleration information, radiation information, illuminance information, and position information of the wearable device. The communication section 30 of the wearable device transmits these kinds of information to the gateway device through the loosely coupled short-range wireless communication.

Specifically, the processing section 20 of the wearable device performs monitoring processing of devices included in the wearable device. The processing section 20 performs, for example, monitoring processing of operation states of the devices. The devices are devices such as the power generating section 40 and the sensor section 54 shown in FIG. 2. Alternatively, the devices may be, for example, devices configuring the communication section 30, the storing section 50, the input section 60, and the output section 62. The communication section 30 transmits monitoring information acquired by the monitoring processing of the devices to the gateway device through the loosely coupled short-range wireless communication.

For example, when the wearable device is a watch (a wristwatch) including turning hands, a device set as a target of the monitoring processing is a motor that drives the hands. For example, the watch includes the motor, a motor driving circuit that drives the motor, and a hand movement mechanism. The hand movement mechanism includes a gear train configured from a plurality of gears rotated by the motor and hands (a second hand, a minute hand, and an hour hand) rotated by the gear train. A load on the rotation of the motor fluctuates according to temperature, a change over time, a state of lubrication, an external magnetic field, or the like. The motor driving circuit changes the number of pulse stages (the length of a pulse width and a duty in a PWM) of a pulse signal for driving the motor such that driving is optimal with respect to a state of the load. The motor driving circuit outputs an auxiliary pulse signal when the motor does not rotate with a first pulse signal. In this case, monitoring information of an operation state of the motor is the pulse width of the pulse signal, presence or absence of output of the auxiliary pulse signal, information concerning the external magnetic field, and the like. The communication section 30 transmits the monitoring information acquired by the monitoring processing of the motor to the gateway device through the loosely coupled short-range wireless communication.

When a device set as a monitoring target is the power generating section 40 that generates electric power for operating the processing section 20 and the communication section 30, the processing section 20 performs monitoring processing of at least one of power generation amount information, power consumption amount information, and power balance information of the power generating section 40. The communication section 30 transmits at least one of the power generation amount information, the power consumption amount information, and the power balance information to the gateway device through the loosely coupled short-range wireless communication. For example, the processing section 20 detects a state of power generation of the solar panel 42 shown in FIG. 10B to calculate power generation amount information of the solar panel 42. The processing section 20 calculates, as power consumption amount information, generated electric power of the solar panel 42 and a consumption amount of stored electric power of the secondary battery 46. The processing section 20 calculates power balance information by comparing the power generation amount and the power consumption amount. The communication section 30 transmits the power generation amount information, the power consumption amount information, or the power balance information to the gateway device through the loosely coupled short-range wireless communication.

As shown in FIG. 11B, the monitoring information acquired by the monitoring processing is transmitted from the gateway device GW to the server SV via the Internet. The server SV performs, for example, generation processing of notification information on the basis of the monitoring information. For example, the server SV performs, on the basis of the monitoring information, processing for generating maintenance information, which is notification information. Alternatively, the server SV performs processing for calculating operable time information of the wearable device WD on the basis of the monitoring information.

The maintenance information and the operable time information are transmitted from the server SV to the gateway device GW and transmitted to the wearable device WD by the loosely coupled short-range wireless communication. Notification processing of the maintenance information and the operable time information is performed in the wearable device WD.

That is, the processing section 20 performs notification processing for notifying of, as the notification information, the maintenance information concerning the maintenance of the wearable device. Specifically, the processing section 20 performs notification information for notifying of, as the maintenance information, announcement information concerning a maintenance service of the wearable device. For example, the processing section 20 performs notification processing of announcement information for announcing that the wearable device needs to receive the maintenance service. Alternatively, the processing section 20 performs notification processing for notifying of, as the notification information, operable time information representing an operable time of the wearable device. The operable time information can include information concerning a time in which the wearable device can operate, for example, from time designated by the user. The operable time information is calculated on the basis of, for example, a residual charge amount (residual battery power) of the wearable device. For example, by transmitting a residual charge amount of the secondary battery 46 and a power generation amount of the solar panel 42 shown in FIG. 10B to the server SV as monitoring information, it is possible to calculate the operable time information of the wearable device WD.

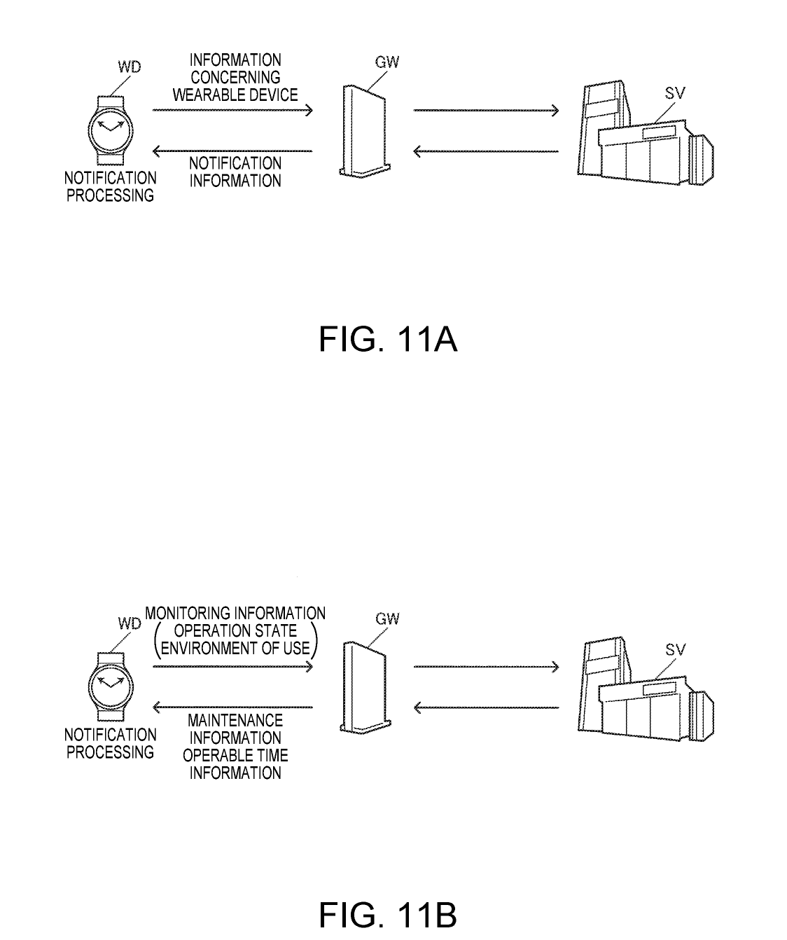

FIG. 12A to FIG. 12C are diagrams showing specific examples of the notification processing. In FIG. 12A, notification processing of maintenance information of the wearable device is performed. Specifically, it is announced that the wearable device needs to receive a specific maintenance service (maintenance). The maintenance information is information for keeping the wearable device in a proper state (a normal state). For example, when it is determined by the server or the like on the basis of the monitoring information such as the operation state of the wearable device that the wearable device is not in the proper state, notification processing of maintenance information for informing to that effect is performed. The notification processing of the maintenance information may be processing for simply notifying that the wearable device needs to receive the maintenance service or may be processing for specifying the maintenance service that the wearable device needs to receive and informing the maintenance service.

In FIG. 12B, notification processing of operable time information of the wearable device is performed. For example, an operable time in an environment of use of the user is notified. For example, an operable time in an average environment of use of the user (an average illuminance environment) may be notified. An operable time in an environment of use under a worst condition (an illuminance environment assumed to be the lowest) may be notified.

In FIG. 12C, notification processing concerning an external magnetic field, which is an environment of use of the user, is performed. For example, when an external magnetic field of the wearable device is detected as monitoring information of an environment of use, information concerning the external magnetic field is notified. For example, when it is detected from a monitoring result of an external magnetic field of a watch, which is the wearable device, that the user frequently wears a magnetic bracelet on an arm, the user is informed that the user should take off the magnetic bracelet and use the watch.

Note that FIG. 12A to 12C show examples of the notification processing in which, for example, the display section of the wearable device is used. However, the notification processing in this embodiment is not limited to this. For example, the notification processing to the user may be realized using a sound output section such as a speaker, a light emitting section such as an LED, a vibration generating section such as a vibration motor, or hands of a watch. Alternatively, the notification processing of the notification information may be performed using an information communication terminal (a terminal connected to the Internet) carried by the user. For example, screens shown in FIG. 12A to FIG. 12C are displayed on a display section of the information communication terminal. In this case, the notification processing performed by the processing section 20 of the wearable device is, for example, processing for instructing or permitting the information communication terminal to perform processing using the display section or the like. For example, presence of some notification information may be informed to the user using a device of the wearable device (e.g., hands of a watch). The server may transmit content of the notification information to an information communication terminal such as a smartphone using an electronic mail or the like. That is, notification processing in a first detail degree is performed in the wearable device. Notification processing in a second detail degree higher than the first detail degree is performed in the information communication terminal.

The processing section 20 performs monitoring processing concerning a plurality of monitoring items of devices of the wearable device and acquires at least one of statistical information concerning each monitoring item of the plurality of monitoring items and log information in time series concerning each monitoring item. The communication section 30 transmits at least one of the statistical information and the log information to the gateway device through the loosely coupled short-range wireless communication.

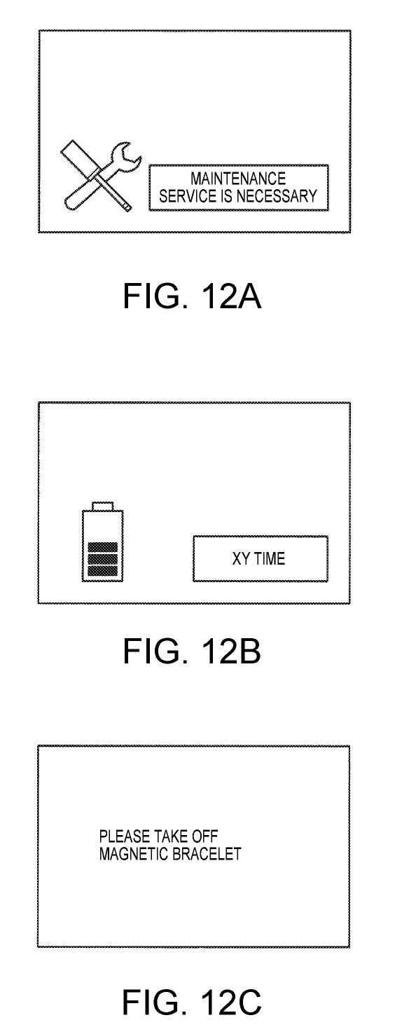

For example, in FIG. 13A, as monitoring items of devices (a power generating section, a sensor section, a motor, etc.) of the wearable device, a plurality of monitoring items MT1, MT2, MT3 are set. Examples of the monitoring items include monitoring items concerning an operation state of a motor of a watch and items such as temperature, humidity, air pressure, magnetism (terrestrial magnetism), weather, the position of the wearable device, a power generation amount, a power consumption amount, or a power balance. In FIG. 13A, kinds of statistical information ST1, ST2, ST3 concerning the respective monitoring items MT1, MT2, MT3 are acquired. These kinds of statistical information ST1, ST2, ST3 are transmitted to the gateway device by the loosely coupled short-range wireless communication. Notification information based on these kinds of statistical information is generated by the server or the like. Notification processing of the notification information is performed. The statistical information is, for example, cumulative data concerning a monitoring result of monitoring processing. Taking a watch as an example, the monitoring result is the number of pulse stages, presence or absence of an output of an auxiliary pulse, presence or absence of rotation, presence or absence of external magnetic field detection, or the like. The statistical information is cumulative data concerning these monitoring results. Note that the statistical information may be average data, distribution data, and the like concerning the monitoring result.

In FIG. 13B, monitoring result data MQ11 to MQ14, MQ21 to MQ24, MQ31 to MQ34 in time series concerning the respective plurality of monitoring items MT1, MT2, MT3 are acquired as log information in time series. For example, log information in which the monitoring result data MQ11 to MQ14, MQ21 to MQ24, MQ31 to MQ34 of the plurality of monitoring items MT1, MT2, MT3 are associated with times when the monitoring processing is executed is acquired. The log information is transmitted to the gateway device by the loosely coupled short-range wireless communication. Notification information based on the log information is generated by the server or the like. Notification processing of the notification information is performed.

A method of using the statistical information shown in FIG. 13A has an advantage that it is possible to reduce a communication amount of the loosely coupled short-range wireless communication. On the other hand, a method of using the log information shown in FIG. 13B has an advantage that it is possible to transmit monitoring information having a higher detail degree to the server and the like, although the communication amount increases.

The user properly uses these two types of methods as appropriate according to a power generation state of the power generating section and a residual charge amount of charging of a charged secondary battery. For example, when the residual charge amount is smaller than a predetermined value, the user automatically switches the wearable device to the method with a less communication amount and achieves power saving.

### 5. Watch

An example in which the method in this embodiment is applied to a watch, which is one kind of the wearable device, is explained.

For example, in a smartphone or a cellular phone, residual battery power can be displayed in detail with a high display ability thereof. However, in the watch, there is also a method of announcing with a second hand or the like that a battery will run out in several hours. However, in the present situation, even simple information concerning whether the residual battery power can last for one more week cannot be notified to the user.

It is important to grasp operation states of devices included in the watch and an environment of use of the user.

For example, in a machine mechanism such as a hand movement mechanism of the watch, a mechanical load fluctuates because of temperature, a change over time, a state of lubrication, an external magnetic field, or the like. For example, when the temperature drops, the load increases. When the load increases, the width of a driving pulse of a motor that drives a gear train increase, a consumed current increases, and a battery life decreases. When the product is used for many years, the load increases because of aged deterioration. Further, the load fluctuates because oil is deteriorated. The load also increases because of the external magnetic field, which is an external factor. When the load increases, the consumed current increases, the battery life decreases, and, in the worst case, the watch stops operation. Therefore, measures for reducing the load of the machine mechanism are necessary.

It is also important to grasp an environment of use of the user. For example, if a frequency of exposure of the watch to the external magnetic field is high, the same phenomenon as the phenomenon that occurs when the load is heavy occurs.

By learning the environment of use of the user, it is possible to grasp a situation of the watch that needs to be repaired. For example, when the watch is brought in for repairing because of a failure, a defect is not reproduced in many cases. By reducing such cases, inconvenience of the user bringing in the product many times can be eliminated. A nonsense claim that a product in a non-defective product range is considered a defective product can be treated by learning the environment of use and deviation of a design indicator. For example, in the case of an environment of use in which the user wears a magnetic bracelet on an arm together with the watch, even if only the watch is brought in for repairing, a situation cannot be grasped. Grasp of such a situation has to be determined by measuring the residual magnetization in the watch brought in for repairing. However, if a situation of external magnetization used in the watch can be grasped, it is possible to give more appropriate advice or the like.

At present, when design and evaluation of the product are performed, a standard is created assuming a scene of use of the user. The quality of the product is guaranteed for a long period of years while performing various adjustments. However, the assumption of the scene of use of the user is not always proper. When the product is brought in for repairing of a defect, because a defective product, which is the product in question, is repaired, it is possible to grasp a situation. However, concerning a defective product not brought in, there is no means for learning a situation. Concerning a product treated as a non-defective product, under the present situation, it cannot be grasped whether the product is an operating product within the assumption of the standard.

Therefore, in this embodiment, a bidirectional wireless communication system is mounted on the watch. Firmware for performing processing for accumulating monitoring result data, which is small data, is incorporated in the watch. The small data is periodically or non-periodically uploaded to a server of a manufacturer or the like. A mechanism for treating the small data as big data is constructed in the server. A gap between an environment of use of the user and assumption of the manufacturer is measured on the basis of the big data. It is determined whether the watch is normal, abnormal, or a confirmation required item. If the watch is abnormal, maintenance and inspection is performed or immediate measures are taken. If the watch is the confirmation required item, an experiment or the like is performed for confirmation to take measures. This leads to development of a better product.

That is, in this embodiment, by enabling upload of information concerning various states (an operation state and a state of an environment) of the watch, it is possible to realize maintenance and conservation of the watch and further realize improvement of a technique for development of abetter product by utilizing the information. Preventive conservation can be achieved by collecting information concerning the influence of an environment of use. For example, when a frequency of exposure of the watch to the external magnetic field is high, the same phenomenon as the phenomenon that occurs when the load is heavy occurs. Therefore, it is desirable that information concerning such an external magnetic field can be collected. When the watch includes a power generating section such as a solar panel, it is possible to appropriately predict occurrence of battery exhaustion by grasping a power generation amount, a power consumption amount, and a power balance.

For example, data (small data) for one day to several days only has to be accumulated in a storing section of the watch. Long-term data (big data) is stored in a storing section (a cloud) of the server. The system is operated to analyze the stored data at a frequency of, for example, approximately one month and feed back an analysis result.

The wearable device in this embodiment is constantly connectable to the Internet. Therefore, it is possible to acquire a log of a past history of the wearable device. It is possible to announce more accurate maintenance information, residual battery power information, and the like with display, sound notification, or the like.

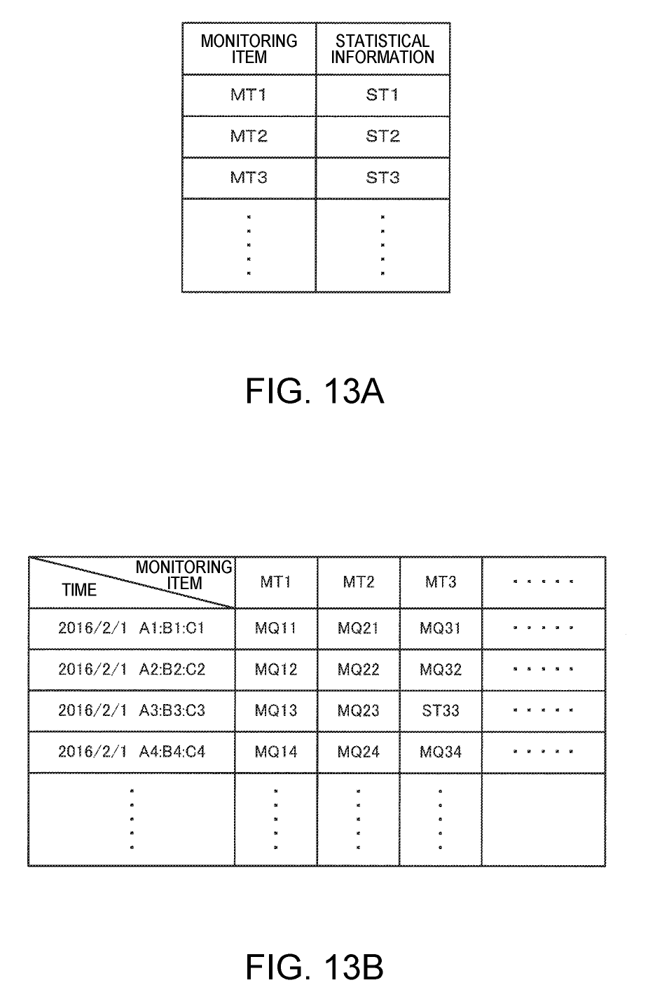

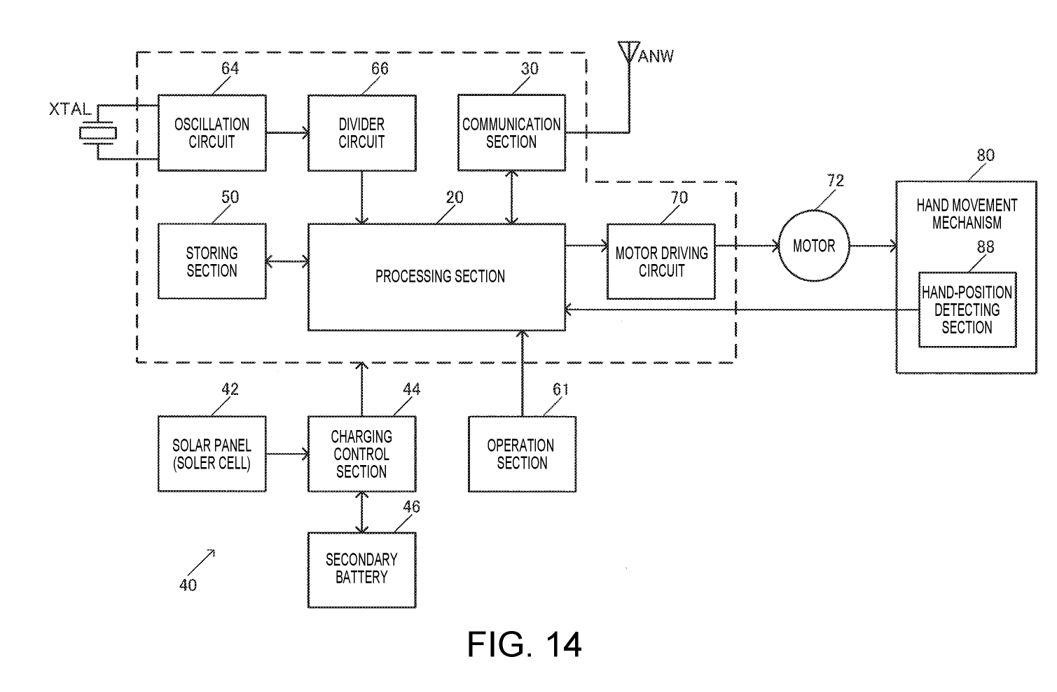

In FIG. 14, a configuration example of the watch (the wristwatch) in this embodiment, which is the wearable device, is shown. In FIG. 15A, a configuration example of a motor 72 and a hand movement mechanism 80 included in the watch is shown. In FIG. 15B, a configuration example of a motor driving circuit 70 is shown. Note that the configurations of the watch, the motor 72, the hand movement mechanism 80, and the motor driving circuit 70 are not limited to the configurations shown in FIG. 14, FIG. 15A, and FIG. 15B. Various modified implementations are possible. For example, a part of components of the watch, the motor 72, the hand movement mechanism 80, and the motor driving circuit 70 can be omitted, other components can be added, or a connection relation of the components can be changed.

An oscillation circuit 64 causes an oscillator XTAL to oscillate to generate a reference signal of 32 KHz or the like. A divider circuit 66 divides the reference signal and supplies a clock signal of, for example, 1 Hz to the processing section 20. The processing section 20 operates on the basis of firmware (a program) or the like stored in the storing section 50 and controls the motor driving circuit 70. The motor driving circuit 70 supplies a driving pulse signal to the motor 72 (a step motor) under the control by the processing section 20 to operate the hand movement mechanism 80 and drive to rotate a second hand 81, a minute hand 82, and an hour hand 83 shown in FIG. 15A. A hand-position detecting section 88 detects hand positions of the second hand 81, the minute hand 82, and the hour hand 83 and outputs a result of the detection to the processing section 20. The communication section 30 performs processing of short-range wireless communication using the antenna ANW. An operation section 61 outputs operation detection signals of a crown and operation buttons of the watch to the processing section 20. The processing section 20, the communication section 30, the storing section 50, the oscillation circuit 64, the divider circuit 66, and the motor driving circuit 70 operate on the basis of generated power supplied from the power generating section 40 configured by the solar panel 42, the charging control section 44, and the secondary battery 46.

As shown in FIG. 15A, the motor 72 includes a coil 73, a stator 74, and a rotor 75. The driving pulse signal supplied from the motor driving circuit 70 is applied to the coil 73, whereby the stator 74 is magnetized. The rotor 75 rotates, for example, 180 degrees with repulsive and attraction forces of the rotor 75 against and to magnetic poles. When the rotor 75 rotates, gears configuring a gear train 84 rotate. The second hand 81, the minute hand 82, and the hour hand 83 are driven to rotate.

As shown in FIG. 15B, the motor driving circuit 70 includes abridge circuit configured by P-type transistors TA1 and TA2 and N-type transistors TA3 and TA4. The motor driving circuit 70 includes a magnetism detection circuit configured by resistors RA1 and RA2, N-type transistors TA5 and TA6, and a detection circuit 71.

In the first period, the transistors TA1 and TA4 of the bridge circuit are turned on by driving pulse signals DR1 and DR4, whereby an electric current flowing from a node N1 to a node N2 flows to the coil 73. In the second period, the transistors TA2 and TA3 of the bridge circuit are turned on by driving pulse signals DR2 and DR3, whereby an electric current flowing from the node N2 to the node N1 flows to the coil 73. The electric current flows to the coil 73, whereby the rotor 75 rotates. When a load is heavy because of calendar feed or the like, the rotor 75 does not completely rotate to be in nonrotation. In this case, rotation and nonrotation of the rotor 75 can be detected by detecting the residual magnetism of the coil 73 with the magnetism detection circuit configured by the resistors RA1 and RA2, the transistors TA5 and TA6, and the detection circuit 71. Specifically, after rotation driving by a driving pulse, rotation and nonrotation can be detected by detecting, with the detection circuit 71 configured by a chopper amplification circuit, voltages induced at both ends of the coil 73. Note that details of the motor driving circuit 70 are disclosed in PTL 3 described above.

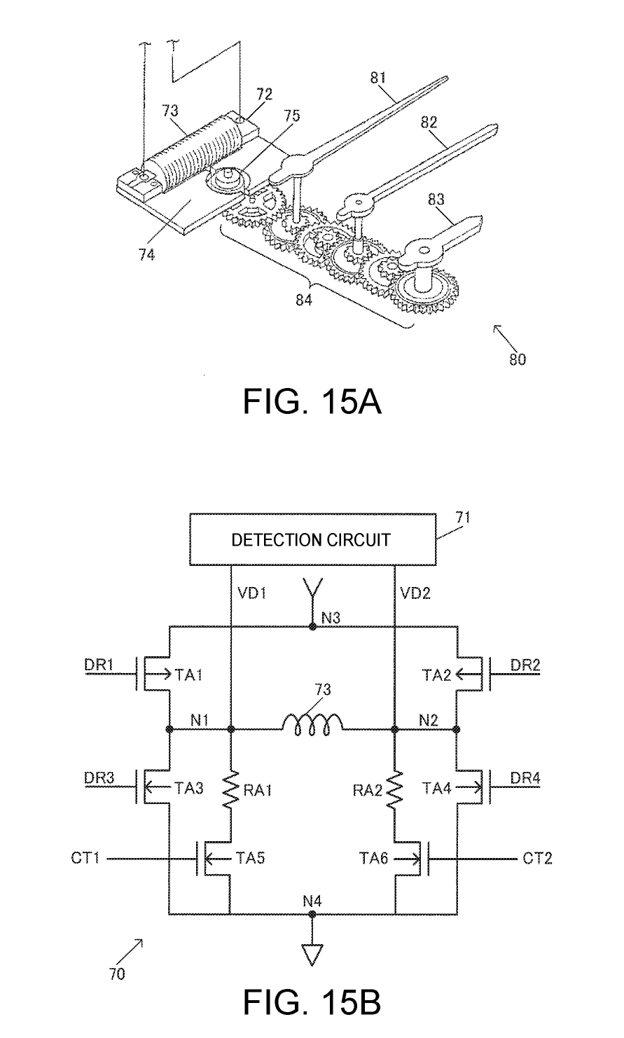

FIG. 16A is a diagram showing a waveform example of a driving pulse signal. Respective kinds of driving are performed at each period of one second specified by a clock signal of 1 Hz supplied from the divider circuit 66 shown in FIG. 14. In FIG. 16A, driving having a positive polarity and driving having a negative polarity are alternately performed.

For example, after rotation driving of the rotor 75 is performed in a driving pulse P1, rotation or nonrotation of the rotor 75 is detected in SP2. SP2 is a sampling period of the driving pulse P1. In SP2, for example, the transistors TA5 and TA6 of the magnetism detection circuit shown in FIG. 15B are turned on by control signals CT1 and CT2 (nonrotation detection pulses). Depending on the driving pulse P1 having a short pulse width, when it is detected in SP2 that the rotor 75 is in nonrotation, an auxiliary pulse P2 having a long pulse width is applied as shown in FIG. 16A. Consequently, even if a load is heavy because of calendar feed or the like, it is possible to properly rotate the rotor 75.

FIG. 16B is a diagram showing a detailed example of a sequence of motor driving. In SP0 and SP1, an external magnetic field is detected. Specifically, in SP0, a high-frequency magnetic field (spike-like electromagnetic noise, etc.) due to a television or the like is detected. In SP1, an alternating-current magnetic field (a magnetic field due to a commercial power supply, etc.) due to an electric heating blanket or the like is detected. The detection of the external magnetic field is realized by detecting, with the magnetism detection circuit explained above, voltages induced at both ends of the coil 73 by the external magnetic field. An erase pulse Pe is a pulse applied in order to cancel the residual magnetism caused by the auxiliary pulse P2 when the auxiliary pulse P2 having a long pulse width is applied.

In the motor driving of the watch, for a reduction in power consumption, the number of pulse stages of the driving pulse P1 are adaptively controlled. The number of pulse stages is equivalent to a pulse width of the driving pulse P1 and a duty in a comb teeth pulse of PWM. For example, as the number of pulse stages is larger, the pulse width is longer and the duty is larger. The rotor 75 can be rotated resisting a larger load. In this embodiment, processing for updating the number of pulse stages (the pulse width and the duty) in each predetermined period (e.g., two minutes) is performed. For example, it is assumed that the number of pulse stages of the driving pulse P1 can be set in a range of 1 to 16 and the number of pulse stages is set to 12. In this case, when the predetermined period (two minutes) elapses, the number of pulse stages of the driving pulse P1 is reduced by, for example, one and set to 11. When the rotor 75 does not rotate, the auxiliary pulse P2 is output to rotate the rotor 75 and reset the number of pulse stages to 12. On the other hand, when the number of pulses is 11 and the rotor 75 rotates, the number of pulse stages is further reduced by one and set to 10. For example, the number of pulse stages is maintained during the predetermined period. Because the number of pulse stages decreases, a motor driving time decreases. Power consumption by the motor driving can be reduced. For example, a load on, for example, the rotation of the rotor 75 fluctuates because of temperature, a change over time, a state of lubrication, or an external magnetic field, or the like. However, if the number of pulse stages is adaptively controlled in this way, it is possible to drive the motor 72 at the number of pulse stages optimal for the fluctuating load. It is possible to realize a reduction in power consumption.

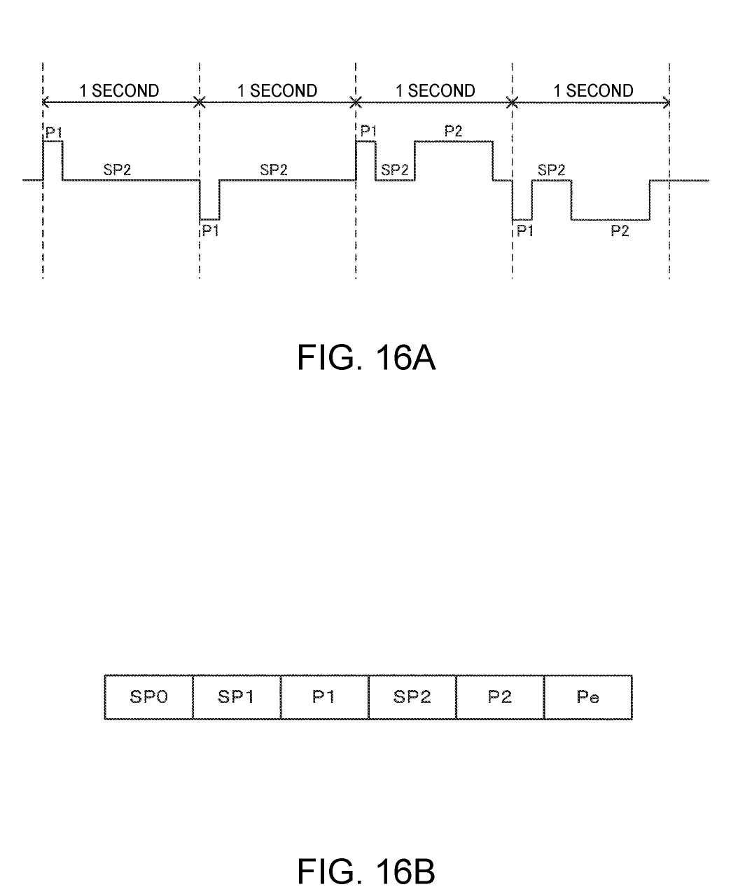

In this embodiment, such monitoring processing of the driving of the motor 72 is performed to acquire statistical information concerning the monitoring items. FIG. 17 is a flowchart of processing for acquiring statistical information on the basis of the monitoring processing of the motor driving.

First, it is determined whether one second has elapsed. When one second has elapsed, a start instruction for hardware processing of pulse generation is performed (steps S1 and S2). For example, the processing section 20 performs a start instruction for hardware processing by the motor driving circuit 70 or the like. The processing section 20 determines whether the hardware processing has ended (step S3).

When the hardware processing has ended, the processing section 20 determines whether an external magnetic field is generated. When an external magnetic field is generated, the processing section 20 increments a value of an external magnetic field generation counter by one (steps S4 and S5). Specifically, when generation of an external magnetic field is detected in SP0 and SP1 of FIG. 16B, the processing section increments the value of the external magnetic field generation counter by one.

Subsequently, the processing section 20 determines whether nonrotation of the rotor 75 is detected. When nonrotation of the rotor 75 is detected, the processing section 20 increments a value of the nonrotation counter by one (steps S6 and S7). Specifically, when nonrotation of the rotor 75 is detected in SP2 of FIG. 16A and FIG. 16B, the processing section 20 increments the value of the nonrotation counter by one.

Subsequently, the processing section 20 determines the number of pulse stages and increments a value of a pulse counter corresponding to the number of pulse stages by one (steps S8 to S18). For example, when the number of pulse stages is 12, the processing section 20 increments a value of a pulse counter at a twelfth stage by one. When the number of pulse stages decreases by one from 12 to be 11, the processing section 20 increments a value of a pulse counter at an eleventh stage by one.

By performing the processing shown in FIG. 17 in this way, concerning the monitoring items of the eternal magnetic field, the nonrotation detection, and the number of pulse stages, statistical information of the monitoring items is generated as a count value of an external magnetic field generation counter, a count value of a nonrotation counter, and count values of pulse counters corresponding to the numbers of pulse stages. A hardware circuit such as the motor driving circuit 70 executes generation of a driving pulse, an auxiliary pulse, and the like and control of the number of pulse stages. A result of the execution is stored in a register. By processing the result in a software manner, it is possible to generate statistical information for maintenance as explained with reference to FIG. 17. The statistical information accumulated in this way is uploaded to the server by the loosely coupled short-range wireless communication via the gateway device, for example, at every predetermined communication interval. After the upload, the counters are cleared. Operation for performing accumulation of statistical information is repeated until the next communication timing.

For example, a frequency of generation of an external magnetic field can be grasped, for example, on the basis of the counter value of the external magnetic field generation counter. A frequency of generation of the auxiliary pulse P2 can be grasped on the basis of the count value of the nonrotation counter. A frequency distribution and the like of the number of pulse stages can be obtained on the basis of the count values of the pulse counters of the numbers of pulse stages. Consequently, it is possible to grasp a situation of a load of the hand movement mechanism 80 and grasp a situation of a load that fluctuates because of, for example, temperature, a change over time, and a lubrication state.

For example, when the number of pulse stages is always high or when the auxiliary pulse P2 is continuously generated, it is possible to determine that a strong external magnetic field due to a magnetic bracelet or the like is present or determine that a lubrication state is deteriorated. In this case, for example, the notification processing shown in FIG. 12A is performed to propose the user to receive a maintenance service or perform the notification processing such as advice shown in FIG. 12C. If requested by the user, initialization of the watch, update of the firmware, or the like is executed through the Internet.

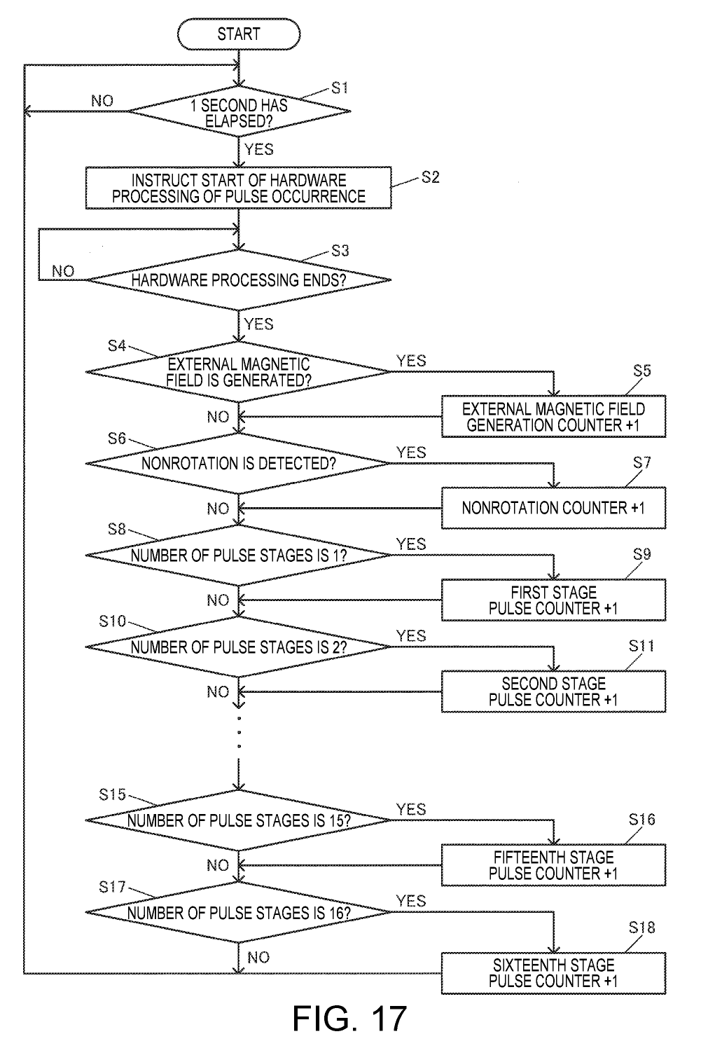

FIG. 18 is an example of log information acquired on the basis of the monitoring processing. In the log information shown in FIG. 18, information such as an external magnetic field, nonrotation detection, the number of pulse stages, a power generation state, a charging state, temperature, humidity, air pressure, a GPS position, acceleration, or a pulse is recorded in association with times. The log information is uploaded to the server by the loosely coupled short-range wireless communication via the gateway device.

For example, it is possible to determine on the basis of the monitoring items of the power generation state and the charging state whether a power balance between solar power generation and power consumption of the watch is within an assumed specified range. It is possible to grasp an environment of use of the user on the basis of the monitoring items of the temperature, the humidity, the air pressure, the magnetism (direction), and the acceleration. For example, a use temperature in an environment of the user can be confirmed according to the monitoring item of the temperature. Water proof performance and a state of dew concentration can be confirmed according to the monitoring item of the humidity. The north latitude and the east longitude of the position of the user are seen on the basis of the monitoring item of the GPS position. It is possible to predict weather (illuminance of the sunlight, etc.) in an environment of use. It is possible to grasp a stock state indicating whether the watch is placed in a store or a warehouse or put in a drawer of a desk of the user. As the monitoring items in the watch, besides, various items such as detection of a deviation amount of an oscillation frequency of quartz, a time reception success ratio in a radio wave timepiece, an implementation frequency of automatic hand position detection and hand position correction, and an inner magnetization amount by a magnetic sensor can be assumed.

As explained above, according to this embodiment, by uploading monitoring information concerning an environment of operation and an environment of use of the wearable device such as the watch to the server through the loosely coupled short-range wireless communication, it is possible to perform failure diagnosis and deterioration diagnosis of the wearable device. By feeding back result data of the failure diagnosis and the deterioration diagnosis to the user with the notification processing or feeding back the result data to a repairing company, it is possible to prevent a failure beforehand or accurately determine a history in the past during repairing. The result data can also be used as information for producing a product having much better quality during development of the next product. For example, it is possible to improve mechanical and electrical quality of the product including, for example, a motor to a gear train and improve the quality of software processing.

In the wearable device such as the watch, consumption of a battery greatly changes according to a state of use of the wearable device. Therefore, accurate timing of battery exhaustion cannot be grasped simply with a time from battery replacement. In this regard, in this embodiment, by storing a state of use of the wearable device in a maintenance management server (a database) by the constant connection by the loosely coupled short-range wireless communication and severally reading out information concerning the state of use, it is possible to realize appropriate maintenance processing for notifying of battery exhaustion.

### 6. Remote Control

In this embodiment, remote control of a control object in which the loosely coupled short-range wiring communication is used is realized. Specifically, as shown in FIG. 1 and FIG. 2, the control system in this embodiment includes the wearable device 10 including the processing section 20 that processes information and the communication section 30 that performs the loosely coupled short-range wireless communication between the communication section 30 and an external device, the short-range wireless communication network BNT including the gateway devices (GW1 to GWN), to which an unspecified large number of devices are connectable, and connectable to the computer communication network INT, and the control objects (the elevator EV, the smart house HS, the robot RB, and the automobile CA). The wearable device 10 is communicatively connected to the gateway device by the loosely coupled short-range wireless communication and communicatively connected to the computer communication network INT via the gateway device.

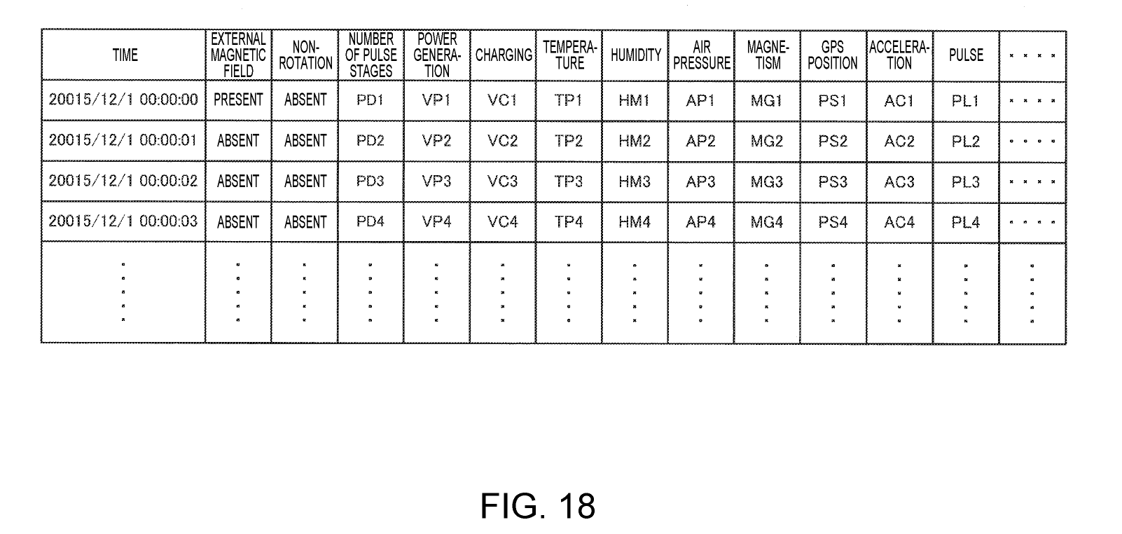

As shown in FIG. 19, in this embodiment, the control objects (the elevator EV, the smart house HS, the robot RB, and the automobile CA) are automatically remotely controlled (in a broad sense, controlled) by the computer communication network INT. For example, the remote control of the control objects is realized by, for example, processing of the server SV and distributed processing of the server SV and the wearable device WD. For example, the processing section 20 shown in FIG. 2 performs processing for automatically remotely controlling, with the computer communication network INT, the control objects used by the user.

Processing for remotely controlling a control object is, for example, processing in which the processing section 20 instructs or permits the remote control of the control object. Alternatively, the processing for remotely controlling the control object is, for example, processing for transmitting information for performing the remote control. The information for performing the remote control is, for example, instruction information and permission information for the remote control and information for authentication and information for behavior prediction of the user for the remote control.

As the control object, for example, as shown in FIG. 19, a control target machine (control target equipment) such as the elevator EV, the smart house HS, the robot RB, or the automobile CA can be assumed. However, the control object is not limited to these control target machines. For example, as the control object, various devices (equipment) such as a personal computer, a security device provided in a facility such as a company, cooling and heating devices, a device related to a bath, various devices provide in an amusement facility, a restaurant, and a store, a parking lot device, a vending machine, a financial related device such as an ATM, a medical device and a health care related device, or a disaster related device can be assumed.

For example, when the control object is the elevator EV, when the user, who is a user of the elevator EV, comes close to a landing of the elevator EV, the elevator EV is remotely controlled to automatically come to the landing. When the user approaches an intersection, a device set in a road or the intersection is remotely controlled to send intersection information and a message for calling attention. Alternatively, a device mounted on the automobile CA near the intersection is remotely controlled to notify a driver of approach of the user, who is a pedestrian. When the control object is a home of the user (the smart house HS) or the automobile CA (a car of the user), when the user approaches the home or the automobile CA, a key is remotely controlled to be automatically locked. When it is determined that the user is about to go back home, devices in the home are remotely controlled to prepare for meeting before the user arrives at home. For example, a switch of the heating device is turned on and hot water is filled in a bathtub. When the user encounters a disaster, the disaster related device is automatically controlled to automatically notify of the position of the user and demand a rescue.

That is, constant connection of the wearable device in this embodiment to the computer communication network is secured by the loosely coupled short-range wireless communication. Therefore, even if there is a position at a distance where a radio wave does not directly reach the control object, it is possible to remotely control the control object through the computer communication network such as the Internet. By using user information stored in the server or the like of the Internet, it is possible to perform preferential processing and behavior prediction control of the user explained below. It is possible to realize unprecedented remote control.

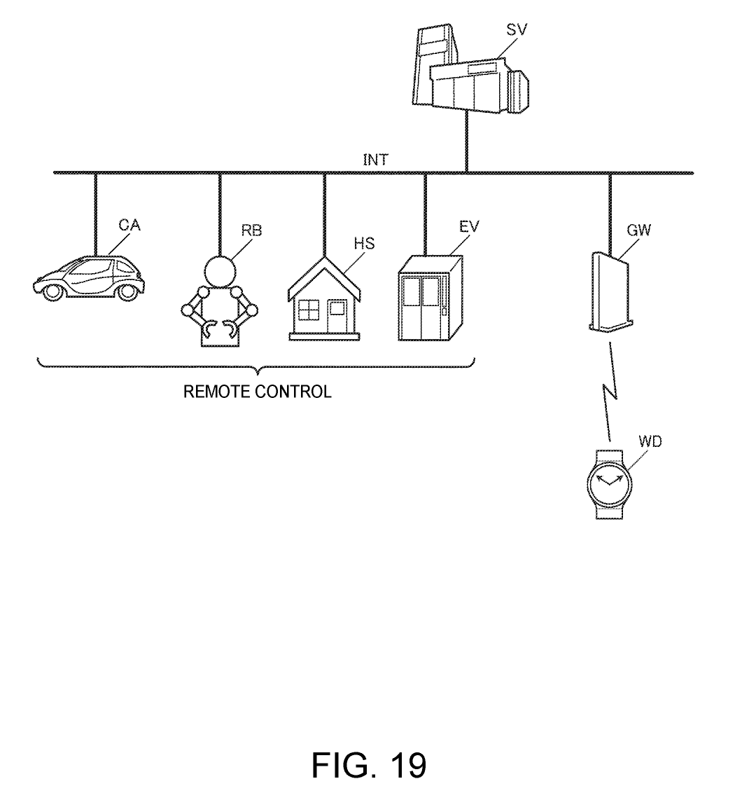

In FIG. 20, a configuration example of the server 200 and the control target device 300, which is the control object, is shown. Note that the configurations of the server 200 and the control target device 300 are not limited to configurations shown in FIG. 20. Various modified implementations are possible. For example, apart of the components can be omitted, other components can be added, and a connection relation can be changed.

The server 200 includes the processing section 220, the communication section 230, and the storing section 250.

The processing section 220 of the server 200 includes an authentication processing section 222, a behavior-prediction processing section 224, and a service-provision processing section 226. The authentication processing section 222 performs authentication processing for authenticating the user. The behavior-prediction processing section 224 performs behavior prediction processing for predicting a behavior of the user. The service-provision processing section 226 performs various kinds of processing for providing a service of remote control of the control target device 300 to the user.

The storing section 250 (a database) of the server 200 includes a user-information storing section 252 and a service-information storing section 254. The user-information storing section 252 stores user information. The user information includes, for example, personal data (a name, a date of birth, a telephone number, etc.) of the user, a user ID and a password concerning the service of the remote control, or specific information (a service ID, etc.) of the service of the remote control provided to the user. The service-information storing section 254 stores information concerning the service of the remote control. For example, the service-information storing section 254 stores various kinds of information concerning the service of the remote control that can be provided to the user.

The control target device 300 includes a control section 320, a communication section 330, a storing section 350, an operation section 360, and a machine mechanism 370.

The control section 320 performs various kinds of control processing of the control target device 300. The control section 320 can be realized by hardware such as an ASIC for control and a processor, various programs, and the like. The communication section 330 performs processing of communication via the computer communication network INT such as the Internet. For example, the communication section 330 performs processing of communication conforming to the specifications of the Ethernet or the TCP/IP. The control target device 300 can be communicatively connected to the computer communication network INT and the server 200 by the communication of the communication section 330. The communication section 330 can be realized by an ASIC for communication, a processor for communication, firmware for communication, or the like.

The storing section 350 stores various kinds of information. The storing section 350 functions as a work area of the control section 320 and the communication section 330. The storing section 350 can be realized by a semiconductor memory (a DRAM or a VRAM), a HDD, or the like. The operation section 360 is a device for performing various kinds of operation of the control target device 300. The machine mechanism 370 is a portion configuring a machine of the control target device 300. The machine mechanism 370 is, for example, a car of an elevator, an arm of a robot, or an engine ora steering mechanism of a car.

In the control system in this embodiment, authentication processing of the user is performed. Remote control of the control object for preferentially processing the user authenticated by the authentication processing is performed.

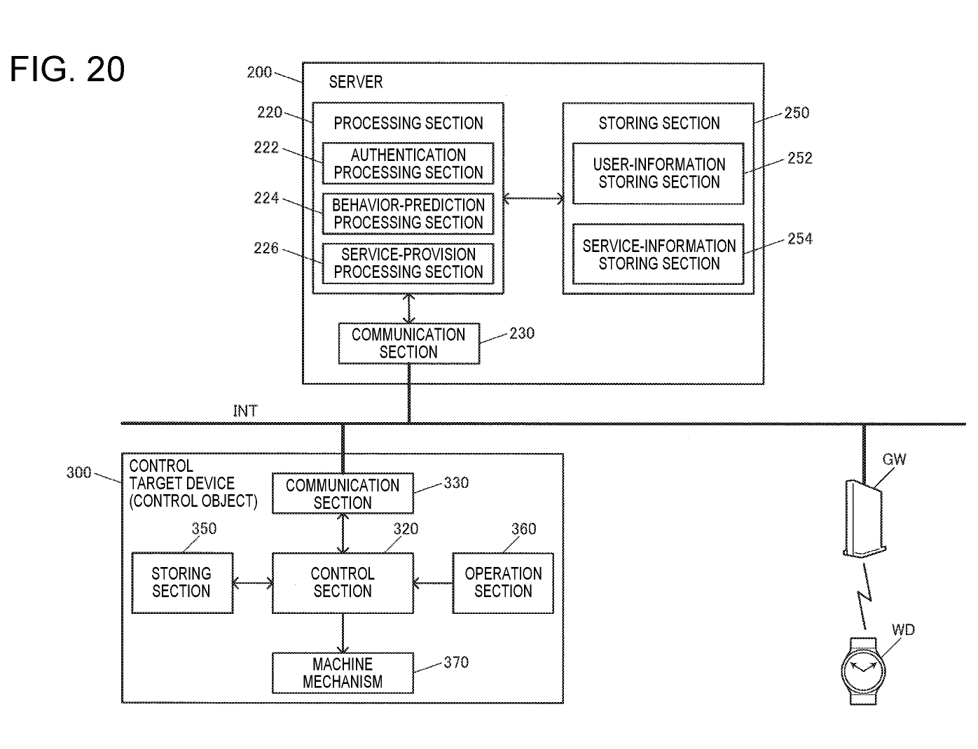

Specifically, as shown in FIG. 21A, the communication section 30 (see FIG. 2) of the wearable device WD transmits information for authentication of the user for performing the remote control for preferentially processing the user to the gateway device GW by the loosely coupled short-range wireless communication. The gateway device GW transmits the information for authentication of the user to, for example, the server SV via the computer communication network INT. Then, the authentication processing section 222 of the server SV shown in FIG. 20 performs authentication processing of the user on the basis of the received information for authentication. For example, the authentication processing section 222 performs processing for authenticating whether the user of the wearable device WD is a formal user registered in the service of the remote control. When it is authenticated that the user is the formal user, the service-provision processing section 226 of the server SV executes permission processing or instruction processing of the service of the remote control. The service-provision processing section 226 transmits information for permitting or instructing the service of the remote control of the preferential processing to, for example, a control object COB. Consequently, the remote control of the control object COB for preferentially processing the user is realized.

The remote control for preferentially processing the user is remote control for preferentially treating the authenticated user compared with other users. For example, as the preferential processing (differentiating processing), processing of VIP treatment is performed on the user. For example, it is assumed that, in a congested restaurant where people are waiting in a long line, a user set as a target of the preferential processing of the VIP treatment is visiting the restaurant. In this case, the remote control of the preferential processing for leading the user into the restaurant through another route is performed. For example, a notification device set in the restaurant is remotely controlled to perform processing for notifying a restaurant manager that the VIP user is visiting the restaurant. Alternatively, a guidance device set in the restaurant is remotely controlled to perform guidance display for moving the VIP user through a route different from other users. That is, in a facility such as a store, a restaurant, or an amusement facility, when a user is a VIP user or the like, devices of the facility is remotely controlled to differentiate the user from other users.

When the control object is a robot and a user set as a target of the preferential processing comes, the robot is remotely controlled to approach the user and provide various services to the user. When the control object is a smart house and a user set as a target of the preferential processing comes, various devices set in the smart house are remotely controlled to provide various services to the user.

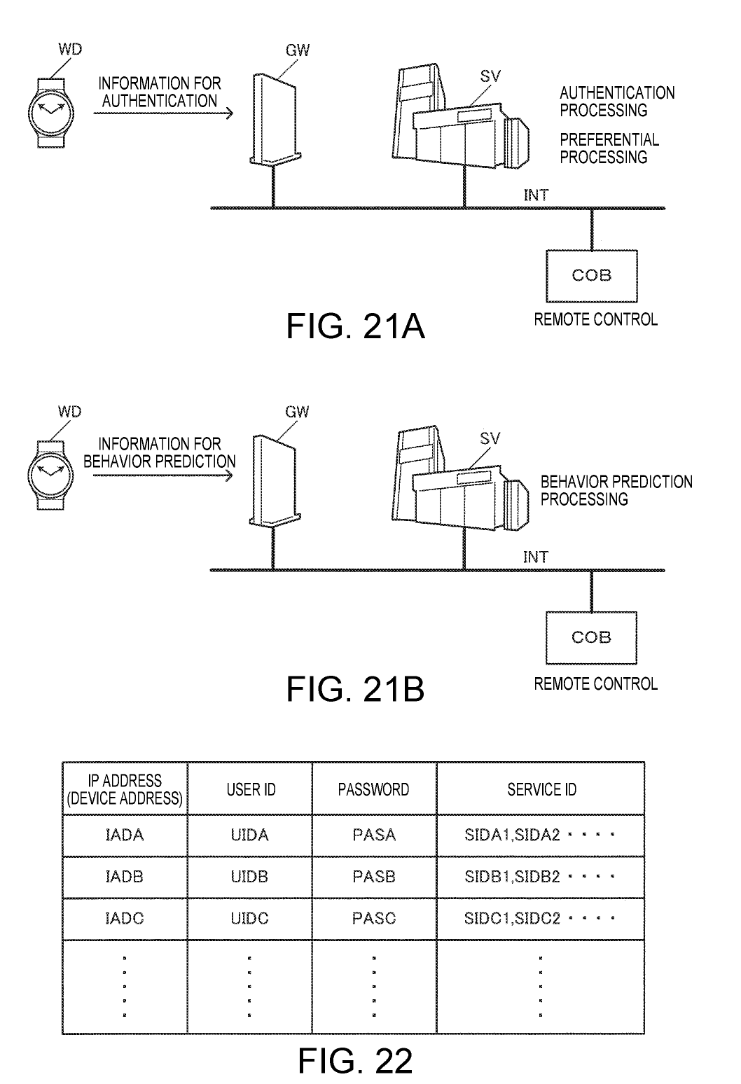

FIG. 22 shows an example of user information stored in the user-information storing section 252. In the user information, for example, a user ID concerning a service of remote control, a password of a user, and a service ID of the remote control are associated with an IP address (a device address) of the wearable device WD. In the service-information storing section 254 shown in FIG. 20, information such as content of service of remote control and a degree (a rank) of preferential processing is stored in association with a service ID. For example, the wearable device WD transmits the device address as information for authentication. The gateway device GW converts the device address into an IP address and transmits the IP address to the server SV. The authentication processing section 222 of the server SV performs authentication processing of the user according to the user information shown in FIG. 22 on the basis of the received IP address. The authentication processing section 222 specifies, according to the service ID associated with the user, a service of remote control provided to the user and executes permission processing or instruction processing of the service of the remote control.

In the control system in this embodiment, behavior prediction processing of the user is performed. Remote control of the control object is performed on the basis of a result of the behavior prediction processing.

Specifically, as shown in FIG. 21B, the communication section 30 of the wearable device WD transmits information for behavior prediction for performing the behavior prediction processing of the user to the gateway device GW through the loosely coupled short-range wireless communication. The gateway device GW transmits the information for behavior prediction to, for example, the server SV via the computer communication network INT. Then, the behavior-prediction processing section 224 of the server SV performs behavior prediction processing of the user on the basis of the received information for behavior prediction. The service-provision processing section 226 of the server SV executes, on the basis of a result of the behavior prediction processing, permission processing and instruction processing of a service of remote control such that remote control of the control object COB is performed.

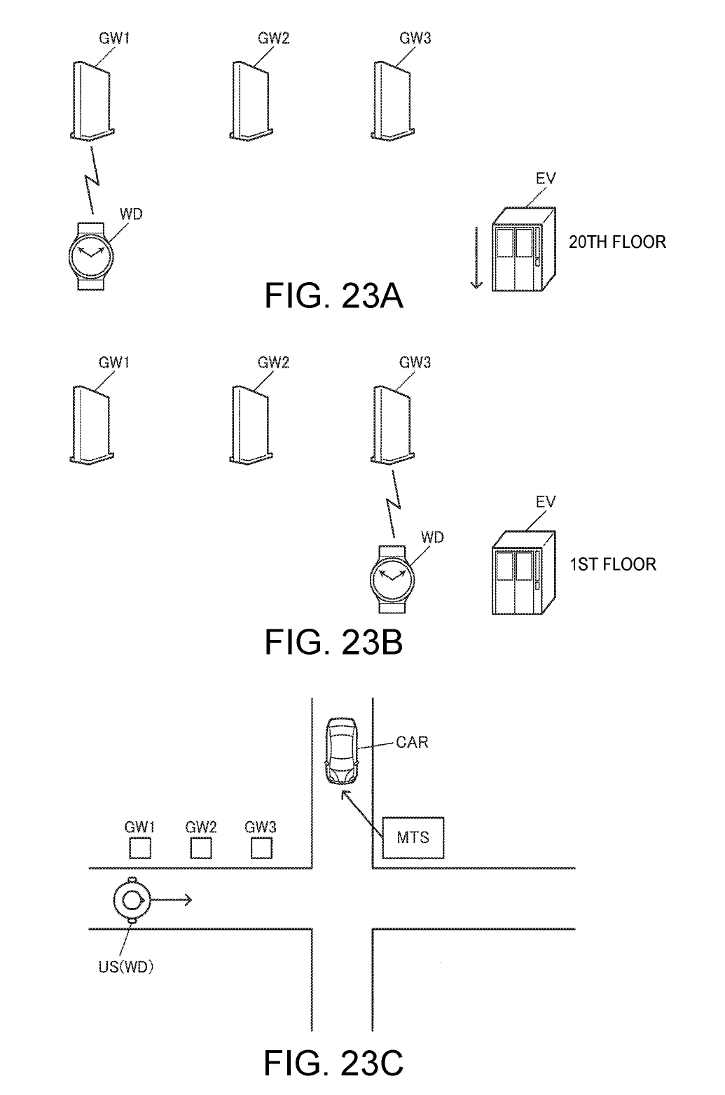

For example, in FIG. 23A and FIG. 23B, the user wearing the wearable device WD is approaching the elevator EV. In this case, in a state shown in FIG. 23A, a descent of the elevator EV has already started. When the user stands in front of the elevator EV, the elevator EV has descended to the first floor where the user is present. That is, as shown in FIG. 23A and FIG. 23B, the wearable device WD is constantly connected to the Internet by the loosely coupled wireless communication via the gateway devices GW1 to GW3. Therefore, a position and a moving route of the user can be predicted by the behavior prediction processing on the basis of, for example, position information (GPS) uploaded from the wearable device WD and connection history information of the gateway devices GW1 to GW3 explained below. Therefore, it is possible to remotely control the elevator EV as shown in FIG. 23A and FIG. 23B on the basis of a result of the behavior prediction processing.

Similarly, in FIG. 23C, it is predicted that a user US wearing the wearable device WD is approaching an intersection. The behavior prediction processing of the user US is realized by the wearable device WD being constantly connected to the Internet via the gateway devices GW1 to GW3. In FIG. 23C, it is detected by a monitoring device MTS that an automobile CAR is approaching the intersection. In this case, devices set in roads and the intersection are remotely controlled to perform notification processing such as attention calling to the user US for whom it is predicted that the intersection is close. Alternatively, a device mounted on the automobile CAR is remotely controlled to perform notification processing for notifying a driver of the automobile CAR of approach of a pedestrian.

If the behavior prediction processing of the user is performed in this way, compared with when the remote control is performed without performing the behavior prediction processing, a temporal margin is generated for the remote control. It is possible to realize more appropriate remote control reflecting a behavior of the user.

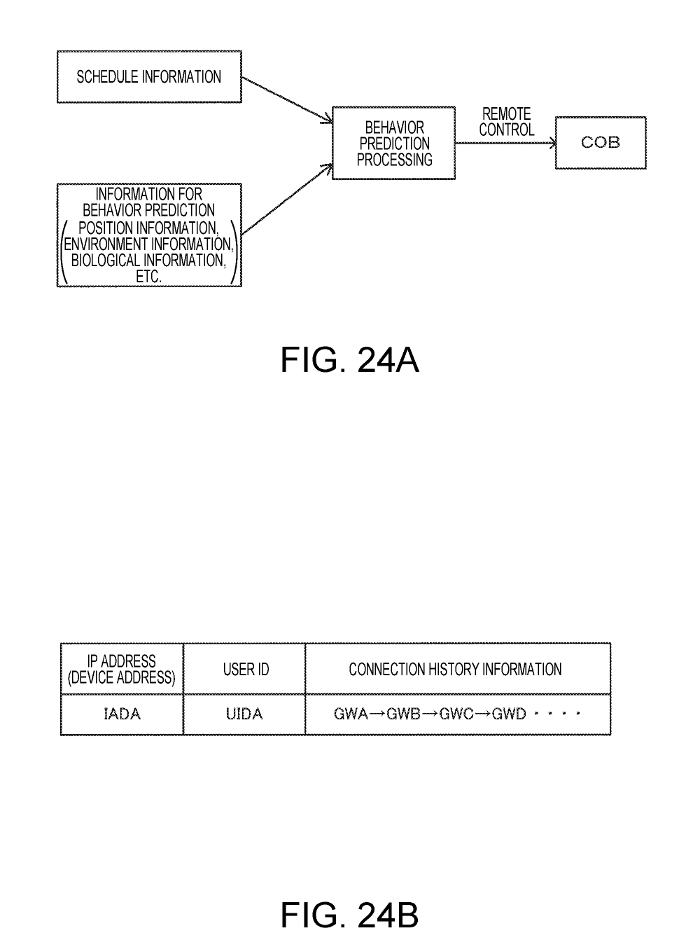

In the control system in this embodiment, the behavior prediction processing of the user is performed on the basis of at least one of information acquired from the wearable device by the loosely coupled short-range wireless communication and schedule information of the user. For example, in FIG. 24A, the behavior prediction processing of the user is performed on the basis of information for behavior prediction, which is the information acquired from the wearable device, and the schedule information of the user. The remote control of the control object COB is performed on the basis of a result of the behavior prediction processing.

Specifically, the communication section 30 of the wearable device transmits, as the information for behavior prediction, at least one of position information of the wearable device, environment information measured by the wearable device, and biological information of the user measured by the wearable device to the gateway device through the loosely coupled short-range wireless communication. The behavior prediction processing of the user is performed on the basis of the position information, the environment information, or the biological information and the scheduled information. The remote control of the control object COB is executed.

For example, position information of the user can be acquired on the basis of a GPS provided in the wearable device. In the schedule information, a schedule concerning when and where the user is present is described. Therefore, by using both of the position information and the schedule information, it is possible to realize more highly accurate behavior prediction processing and realize more appropriate remote control. Further, if the behavior prediction processing is performed taking into account, for example, environment information such as temperature, humidity, air pressure, or weather in the position of the wearable device and biological information of the user and the remote control of the control object is performed, it is possible to realize appropriate remote control corresponding to a situation and a state of the user. For example, by using the environment information, it is possible to predict a behavior of the user corresponding to a state of an environment (e.g., weather). By using the biological information such as a pulse of the user, it is possible to determine whether the user is in a hurry.

In the control system in this embodiment, the behavior prediction processing of the user may be performed on the basis of connection history information of a plurality of gateway devices communicatively connected to the wearable device by the loosely coupled short-range wireless communication. For example, an example of the connection history information is shown in FIG. 24B. The connection history information is stored in, for example, the storing section 250 of the server in association with, for example, an IP address (a device address) of the wearable device and a user ID. Connection history information shown in FIG. 24B indicates that the wearable device of the user is communicatively connected to gateway devices GWA, GWB, GWC, and GWD in this order. It is possible to predict a moving route or the like of the user and perform behavior prediction of the user using such connection history information of the gateway devices.

For example, the server can acquire information concerning setting positions of the gateway devices GWA, GWB GWC, and GWD. Therefore, it is possible to predict a position and a moving route of the user by using the setting positions and the connection history information shown in FIG. 24B. For example, with the GPS, it is difficult to detect the position of the user indoors. However, if the connection history information shown in FIG. 24B is used, it is possible to predict a position and a moving route of the user and predict a behavior of the user even indoors or the like. It is possible to realize proper remote control on the basis of a result of prediction processing. Such connection history information can be used because each gateway device of the plurality of gateway devices of the short-range wireless communication network and the wearable device of the user are constantly connected by the loosely coupled short-range wireless communication.

In this embodiment, when the user wearing the wearable device such as the watch is leading a life, the wearable device is constantly connected to the Internet by the loosely coupled short-range wireless communication. Electric power is generated by solar power generation or the like to operate the wearable device with low power to prevent the wearable device from being taken off from an arm or the like to charge the wearable device. Because the loosely coupled short-range wireless communication consumes little electric power, it is easy to operate the wearable device with low power. Even if the user wearing the wearable device moves to various places, because the wearable device and the gateway device are connected by the loosely coupled wireless communication in which pairing is not performed, complicated processing such as release of pairing is unnecessary. On the other hand, comparison of the schedule information of the user registered in the server or the like and the present time, comparison of a position in the past and the present position, and the like are performed. For a behavior analysis of each person, artificial intelligence and deep learning are performed and behavior prediction of the user is performed. Consequently, it is possible to comprehensively determine information indicating how many minutes earlier the user tends to enter a destination, indicating that the user is in a hurry because of the speed of a pulse, indicating that the user has time to spare because the user is moving slowly. It is possible to realize the remote control of the control object. The user has an advantage that, simply by wearing the wearable device, the user can be automatically provided with a highly valuable service corresponding to a behavior of the user even by a remote device to which a radio wave does not directly reach.

### 7. Control Target Device

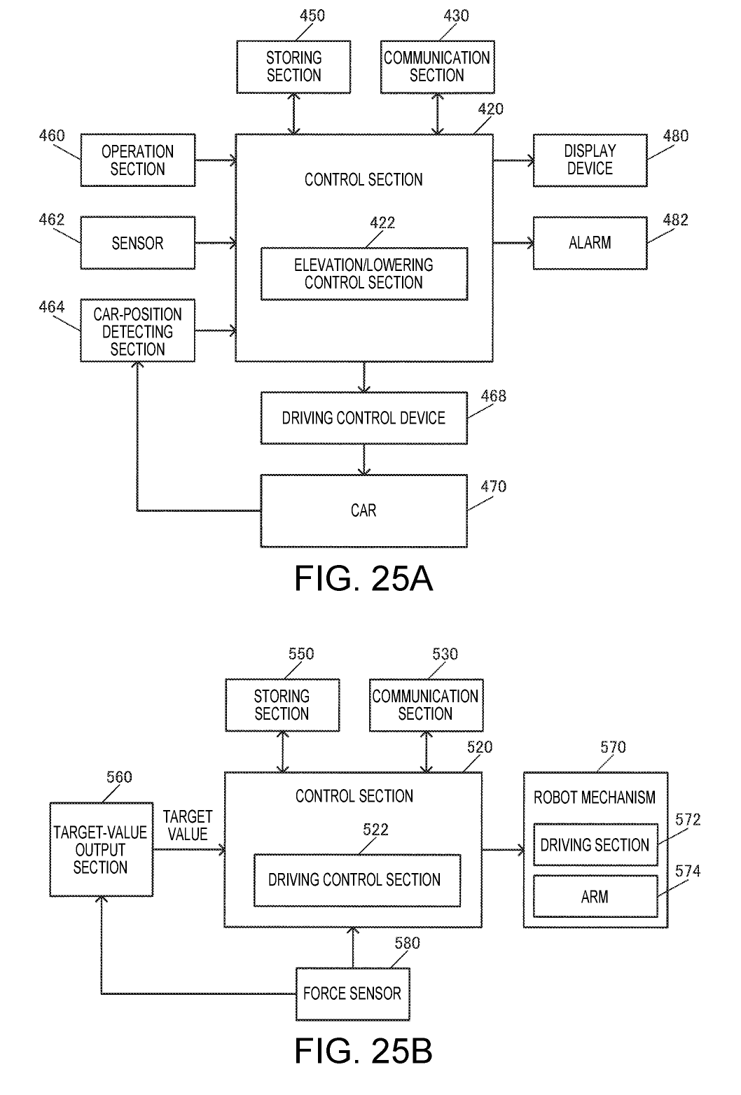

In FIG. 25A, a configuration example of an elevator (EV), which is an example of the control target device, is shown. The elevator shown in FIG. 25A includes a control section 420, a communication section 430, a storing section 450, an operation section 460, a sensor 462, a car-position detecting section 464, a driving control device 468, a car 470, a display device 480, and an alarm 482.

The control section 420 performs various kinds of control processing of the elevator. The control section 420 can be realized by hardware such as an ASIC for control or a processor, various programs, and the like. The control section 420 includes an elevation/lowering control section 422 that performs elevation/lowering control processing of the car 470.

The communication section 430 performs processing of communication conforming to the specifications of the Ethernet or the TCP/IP and communicatively connects the elevator to the computer communication network INT. The storing section 450 is configured by a semiconductor memory or the like and stores an operation program of the elevator and various data. The operation section 460 is a section for the user to perform operation of the elevator. The operation section 460 includes landing buttons provided in a landing and destination buttons provided in the car 470. The sensor 462 is a sensor that detects a fire, earthquake, power failure state and the like. The car-position detecting section 464 detects the position of the car 470 and outputs a detection signal to the control section 420. The car-position detecting section 464 detects the position of the car 470 and outputs a detection signal to the control section 420. The driving control device 468 controls a winding motor and a door motor of the car 470. The car 470 is a portion on which people ride. The car 470 is elevated and lowered by the winding motor. The display device 480 displays occurrence of a fire, earthquake, or power failure state to the user. The alarm 482 notifies the occurrence of the fire, earthquake, or power failure state with sound or the like.

When performing the remote control explained with reference to FIG. 23A and FIG. 23B, the control section 420 receives instruction information or permission information of the remote control, designation information of service content, or the like from the server or the like via the computer communication network INT and the communication section 430. Alternatively, the control section 420 may receive these kinds of information from the wearable device WD directly or via the computer communication network INT and the communication section 430. The elevation/lowering control section 422 of the control section 420 executes elevation/lowering control of the elevator to start a descent of the car 470 at timing shown in FIG. 23A and allow the car 470 to reach a floor of a landing of the user at timing shown in FIG. 23B. In this case, a program module for executing the remote control processing (the service processing and the preferential processing) shown in FIG. 23A and FIG. 23B is incorporated in the operation program stored in the storing section 450. The elevation/lowering control section 422 executes the remote control processing according to the program module.

In FIG. 25B, a configuration example of a robot (RB), which is an example of the control target device, is shown. The robot shown in FIG. 25B includes a control section 520 a communication section 530, a storing section 550, a target-value output section 560, a robot mechanism 570, and a force sensor 580.

The control section 520 is a section that performs various kinds of control processing of the robot. The control section 520 can be realized by hardware such as an ASIC for control or a processor, various programs, and the like. The control section 520 includes a driving control section 522 that performs driving control processing of the robot mechanism 570. The communication section 530 performs processing of communication conforming to the specifications of the Ethernet or the TCP/IP and communicatively connects the robot to the computer communication network INT. The storing section 550 is configured by a semiconductor memory or the like and stores a robot control program and various data.

The target-value output section 560 output a target value of feedback control of the robot on the basis of sensor information and the like output from the force sensor 580. Feedback control of the robot is realized on the basis of the target value. The target-value output section 560 can include a track generating section and an inverse-kinematics processing section. The force sensor 580 is a sensor for performing force control such as impedance control of the robot. The force sensor 580 is attached to a wrist portion or the like of an arm 574 of the robot. The force sensor 580 outputs a detected force or moment as sensor information. The robot mechanism 570 includes a driving section 572 and the arm 574. The driving section 572 is a driving mechanism for moving joints of the arm 574 of the robot and moving the robot. The driving section 572 is configured by a motor or the like. By performing driving control of the driving section 572 with the driving control section 522 of the control section 520, it is possible to move the arm 574 (double arms or a single arm) of the robot and move the robot.

When performing the remote control in this embodiment, the control section 520 receives instruction information or permission information of the remote control, designation information of service content, and the like from the server or the like via the computer communication network INT and the communication section 530. Alternatively, the control section 520 may receive these kinds of information from the wearable device WD directly or via the computer communication network INT and the communication section 530. The driving control section 522 of the control section 520 performs driving control of, for example, the driving section 572 of the robot mechanism 570 to perform the remote control in this embodiment. For example, when a user set as a target of preferential processing comes, the driving control section 522 performs the driving control such that the robot approaches the user and performs various preferential services. For example, the driving control section 522 controls the robot to move to the user, move the arm 574 to provide the various preferential services, and output, with a not-shown sound output section, various kinds of sound for the preferential services. In this case, a program module for executing remote control processing such as preferential processing is incorporated in the robot control program stored in the storing section 550. The driving control section 522 executes the remote control processing using the program module.

Note that this embodiment is explained in detail above. However, those skilled in the art could easily understand that many modifications not substantially departing from the new matters and the effects of the invention are possible. Therefore, it is assumed that all such modifications are included in the scope of the invention. For example, the terms (the advertising packet, the Internet, the active scan, the wearable device, the loosely coupled short-range wireless communication, etc.) described together with the broader-sense or synonymous different terms (the presence notification packet, the computer communication network, the scan, the electronic device, the short-range wireless communication, etc.) at least once in the specification or the drawings can be replaced with the different terms in any parts of the specification or the drawings. All combinations of this embodiment and the modifications are included in the scope of the invention. The configurations, the operations, and the like of the wearable device, the communication system, the control system, the gateway device, and the server are not limited to those explained in the embodiment. Various modified implementations are possible.

Further, the invention has the following advantages because the wearable device is used. That is, the wearable device is worn on the body and is not left behind. With a vibration function or the like, the user can directly sense necessary information in the body, for example, even while taking a shower. Even if a physical problem occurs while the user is taking a bath, the user can automatically request and provide information. Further, safe, healthy, and comfortable life can be obtained. Because the wearable device is hands-free, the motion of the user is not limited during driving of an automobile. The user can unknowingly use the wearable device without stopping concurrently ongoing other work.

In the communication in the invention, secure communication applied with measures against impersonation is necessary. During the communication, it is desirable to perform individual authentication by an ID number or biological sensing.

### REFERENCE SIGNS LIST

WT, WT1 to WT3 watch, LD biological sensor device, HMD head-mounted display device, SP information communication terminal, GW, GW1 to GWN gateway device, BNT short-range wireless communication network, INT computer communication network, SV server, EV elevator, HS smart house, RB robot, CA car, WD, WD1, WD2 wearable device, wearable device, 20 processing section, 30 communication section, 40 power generating section, 42 solar panel, 44 charging control section, 46 secondary battery, 50 storing section, 54 sensor section, 60 input section, 61 operation section, 62 output section, 64 oscillation circuit, 66 divider circuit, 70 motor driving circuit, 71 detection circuit, 72 motor, 73 coil, 74 stator, 75 rotor, 80 hand movement mechanism, 81 second hand, 82 minute hand, 83 hour hand, 84 gear train, 88 hand-position detecting section, 100 gateway device, 120 processing section, 130, 140 communication section, 150 storing section, 200 server, 220 processing section, 230 communication section, 250 storing section

1. A wearable device comprising:
a processing section configured to process information; and
a communication section configured to perform loosely coupled short-range wireless communication between the communication section and an external device, wherein
the communication section is communicatively connected to a gateway device, to which an unspecified large number of devices are connectable, by the loosely coupled short-range wireless communication and communicatively connected to the computer communication network via the gateway device, and
the processing section performs notification processing of notification information acquired on the basis of transmission of information concerning the wearable device by the loosely coupled short-range wireless communication.

2. The wearable device according to claim 1, wherein the processing section performs notification processing for notifying of maintenance information concerning maintenance of the wearable device.

3. The wearable device according to claim 2, wherein the processing section performs notification processing for notifying of, as the maintenance information, announcement information concerning a maintenance service for the wearable device.

4. The wearable device according to claim 1, wherein the processing section performs notification processing for notifying of, as the notification information, operable time information representing an operable time of the wearable device.

5. The wearable device according to claim 1, wherein the communication section transmits, as the information concerning the wearable device, monitoring information concerning at least one of an operation state and an environment of use of the wearable device to the gateway device through the loosely coupled short-range wireless communication.

6. A wearable device comprising:
a processing section configured to process information; and
a communication section configured to perform loosely coupled short-range wireless communication between the communication section and an external device, wherein
the communication section is communicatively connected to a gateway device, to which an unspecified large number of devices are connectable, by the loosely coupled short-range wireless communication and communicatively connected to the computer communication network via the gateway device, and
the communication section transmits monitoring information concerning at least one of an operation state and an environment of use of the wearable device to the gateway device through the loosely coupled short-range wireless communication.

7. The wearable device according to claim 5, wherein
the processing section performs monitoring processing of a device included in the wearable device, and
the communication section transmits the monitoring information acquired by the monitoring processing to the gateway device through the loosely coupled short-range wireless communication.

8. The wearable device according to claim 7, wherein
the processing section performs monitoring processing concerning a plurality of monitoring items of the device and acquires at least one of statistical information concerning each monitoring item of the plurality of monitoring items and time-series log information concerning the each monitoring item, and
the communication section transmits the at least one of the statistical information and the log information to the gateway device through the loosely coupled short-range wireless communication.

9. The wearable device according to claim 7, wherein
the wearable device is a watch including turning hands, and
the device is a motor that drives the hands.

10. The wearable device according to claim 7, wherein
the device is a power generating section configured to generate electric power for operating the processing section and the communication section,
the processing section performs monitoring processing of at least one of power generation amount information, power consumption amount information, and power balance information of the power generating section, and
the communication section transmits at least one of the power generation amount information, the power consumption amount information, and the power balance information to the gateway device through the loosely coupled short-range wireless communication.

11. The wearable device according to claim 5, wherein the communication section transmits, as the monitoring information concerning the environment of use of the wearable device, at least one of magnetic field information, temperature information, humidity information, air pressure information, magnetism information, weather information, gravity information, acceleration information, radiation information, illuminance information, and position information of the wearable device to the gateway device through the loosely coupled short-range wireless communication.

12. The wearable device according to claim 1, wherein the loosely coupled short-range wireless communication is communication performed in a scan period in which the gateway device searches for a presence notification packet transmitted from the wearable device.

13. The wearable device according to claim 12, wherein the communication section transmits information to the gateway device using the presence notification packet or, when the gateway device transmits a request packet in response to the presence notification packet, transmits information to the gateway device using a response packet to the request packet.

14. The wearable device according to claim 12, wherein the communication section receives, in the scan period, from the computer communication network through the loosely coupled short-range wireless communication via the gateway device, information acquired on the basis of information transmitted to the computer communication network via the gateway device.

15. The wearable device according to claim 12, wherein the presence notification packet and the scan period are respectively an advertising packet and an active scan period in a Bluetooth (registered trademark).

16. The wearable device according to claim 1, wherein the communication section performs, in a first period, the loosely coupled short-range wireless communication between the communication section and a first gateway device included in a short-range wireless communication network and performs, in a second period different from the first period, the loosely coupled short-range wireless communication between the communication section and a second gateway device included in the short-range wireless communication network.

17. The wearable device according to claim 1, wherein the communication section is communicatively connected to the gateway device by the loosely coupled short-range wireless communication directly not via another information communication terminal.

18. A wearable device comprising:
a processing section configured to process information; and
a communication section configured to perform short-range wireless communication between the communication section and a gateway device communicatively connected to a computer communication network, wherein
the communication section is communicatively connected to the computer communication network via the gateway device by performing the short-range wireless communication with the gateway device in a scan period in which the gateway device searches for a presence notification packet transmitted from the wearable device, and
the processing section performs notification processing of notification information acquired on the basis of transmission of information concerning the wearable device by the short-range wireless communication.

19. The wearable device according to claim 18, wherein the communication section transmits information to the gateway device using the presence notification packet or, when the gateway device transmits a request packet in response to the presence notification packet, transmits information to the gateway device using a response packet to the request packet.

20. The wearable device according to claim 18, wherein the communication section receives, in the scan period, from the computer communication network through short-range wireless communication via the gateway device, information acquired on the basis of information transmitted to the computer communication network via the gateway device.

21. The wearable device according to claim 18, wherein the presence notification packet and the scan period are respectively an advertising packet and an active scan period in a Bluetooth (registered trademark).

22. The wearable device according to claim 18, wherein the communication section performs, in a first period, the short-range wireless communication between the communication section and a first gateway device included in a short-range wireless communication network and performs, in a second period different from the first period, the short-range wireless communication between the communication section and a second gateway device included in the short-range wireless communication network.

23. A communication system comprising:
a wearable device including a processing section configured to process information and a communication section configured to perform loosely coupled short-range wireless communication between the communication section and an external device; and
a short-range wireless communication network including a gateway device, to which an unspecified large number of devices are connectable, and connectable to a computer communication network, wherein
the wearable device is communicatively connected to the gateway device by the loosely coupled short-range wireless communication and communicatively connected to the computer communication network via the gateway device, and
notification processing to a user is performed concerning notification information acquired on the basis of transmission of information concerning the wearable device by the loosely coupled short-range wireless communication.

24. The communication system according to claim 23, wherein the loosely coupled short-range wireless communication is communication performed in a scan period in which the gateway device searches for a presence notification packet transmitted from the wearable device.
